(19) United States
(12) Patent Application Publication
(10) Pub. No.: US 2013/0194254 A1
(43) Pub. Date: Aug. 1, 2013

(54) IMAGE PROCESSING APPARATUS, IMAGE PROCESSING METHOD AND PROGRAM

(71) Applicant: CANON KABUSHIKI KAISHA, Tokyo (JP)

(72) Inventors: Ai Miyoshi, Kawasaki-shi (JP); Daiki Kondo, Hakodate-shi (JP)

(73) Assignee: CANON KABUSHIKI KAISHA, Tokyo (JP)

(21) Appl. No.: 13/744,933

(22) Filed: Jan. 18, 2013

(30) Foreign Application Priority Data
Jan. 23, 2012 (JP) 2012-011506
Jan. 26, 2012 (JP) 2012-014200

(51) Int. Cl. G06T 15/00

(52) U.S. Cl. CPC G06T 15/005
USPC 345/419

(57) ABSTRACT

Appropriate lighting is easily performed corresponding to a virtual subject position. An image processing apparatus according to the present invention includes a surrounding environment three-dimensional shape data generation unit configured to generate surrounding environment three-dimensional shape data from environment map data having two or more viewpoints, and a virtual subject combining unit configured to combine a virtual subject with background image data, by setting the surrounding environment three-dimensional shape data as a light source.

### BACKGROUND OF THE INVENTION

1. Field of the Invention

The present invention relates to an image processing apparatus, image processing method, and program for generating combined image data of an actually captured background image and a three-dimensional CG object.

2. Description of the Related Art

Combining an unreal virtual subject with a background image by using CG (Computer Graphics) is frequently performed in video image making. In this case, it is necessary to match lighting for the virtual subject with lighting for the background image in order to cause a video image after combining to be natural. An example of a method for the lighting matching is a 3D modeling method of lighting environment. In this case, there is frequently used ray tracing for calculating a light path or lighting using radiosity.

Furthermore, there is also used a method of image-based lighting which captures an all surrounding image (environment map) of a scene where a background image is captured and uses the obtained environment map as a light source image for providing a lighting effect (refer to Peter-Pike Sloan and Ben Luna and John Snyder “Local, Deformable Precomputed Radiance Transfer” SIGGRAPH ACM ACM SIGGRAPH 2005 Papers and Zhong Ren and Rui Wang and John Snyder and Kun Zhou and Xinguo Liu and Bo Sun and Peter-Pike Sloan and Hujun Bao and Qunsheng Peng and Baining Guo “Real-time Soft Shades in Dynamic Scenes using Spherical Harmonic Exponentiation”, SIGGRAPH ACM SIGGRAPH 2006 Papers).

Moreover, there is used a method of performing image-based lighting for a faraway light source and using the 3D model for a proximity light source for providing a lighting effect (refer to Shiho Furuya and Takayuki Itou “Image Based Lighting with pictures shooting proximity light Sources” National Convention of IPSJ Papers).

In the above conventional method using the image-based lighting, in the case where the position of a virtual subject is changed, it is necessary to prepare in advance an environment map corresponding to the position after the change. This is because, in the case where the position of the virtual subject is changed, a positional relationship between the virtual subject and a light source is also changed. If positions of the virtual subject after the change are known in advance, a limited number of environment maps corresponding to the positions after the change may be prepared. However, the number of the positions for the virtual subject is considered to be countless, and thus it is not possible to prepare, in advance, the environment maps corresponding to all the possible positions.

Furthermore, in the above conventional method using the ray tracing or the radiosity, it is necessary to manually perform the 3D modeling of lighting environment on a scene where a background image is captured, and thus it takes time.

Further features of the present invention will become apparent from the following description of exemplary embodiments (with reference to the attached drawings).

### SUMMARY OF THE INVENTION

An image processing apparatus according to the present invention is provided with a surrounding environment three-dimensional shape data generation unit configured to generate surrounding environment three-dimensional shape data from environment map data having two or more viewpoints; and an image generation unit configured to generate an image of a virtual subject by using the surrounding environment three-dimensional shape data as a light source.

According to the present invention, it is possible to easily perform appropriate lighting corresponding to the position of the virtual subject, in generating combined image data of the background image and the virtual subject.

### BRIEF DESCRIPTION OF THE DRAWINGS

FIG. 1 is a diagram showing a system configuration example of an image processing apparatus according to example 1;

FIG. 2 is a functional configuration diagram of an image processing apparatus according to example 1;

FIG. 3 is a flowchart showing the whole image processing flow executed in an image processing apparatus according to example 1;

FIG. 4 is an external view of an image capturing device configured to capture a background image and an environment map according to example 1;

FIG. 5A is a diagram showing an example of a background image, FIG. 5B is a diagram showing an example of an environment map, and FIG. 5C is a diagram showing an image capturing situation of the environment map of FIG. 5B;

FIG. 6 is a diagram explaining a distance calculation method;

FIG. 7 is a flowchart showing a flow of distance map generation processing;

FIG. 8 is a diagram showing an example of a distance map;

FIG. 9 is a flowchart showing a flow of unnecessary subject removal processing in the case where a proximity subject is removed;

FIGS. 10A and 10B are diagrams showing a state in which a pixel value within a block set in a removal region on a distance map is replaced by a pixel value within a block set in a reference region;

FIGS. 11A to 11D are diagrams showing examples of an environment map and a distance map in which person's faces are removed by unnecessary subject removal processing;

FIG. 12 is a flowchart showing a flow of surrounding environment three-dimensional shape data generation processing;

FIG. 13A is a diagram showing a relationship between an environment map and three-dimensional coordinates EV_{Data}, and

FIG. 13B is a diagram showing three-dimensional coordinates EV_{Data} for an environment map captured at the center of a room as shown in FIG. 5C;

FIG. 14 is a diagram showing an example of polygon data;

FIG. 15 is a diagram showing an example of a file format for polygon data;

FIG. 16 is a diagram explaining a state in which a revised environment map is designated to be copied to polygon data;

FIG. 17 is a flowchart showing a flow of virtual subject combining processing;

FIG. 18 is a flowchart showing a flow of color signal value calculation processing for a virtual subject;

FIG. 19 is an exemplary diagram showing a relationship between an emitted light ray and a virtual subject;

FIG. 20A is a diagram expressing a relationship between a surrounding environment three-dimensional shape used for lighting in a present example and a virtual subject, and

FIG. 20B is a diagram showing an example of a combined image combining the virtual subject with a background image;

FIGS. 21A to 21C are diagrams showing an image capturing device provided with a larger number of environment map capturing units according to example 2;

FIG. 21A is a diagram showing an image capturing device in which two environment map capturing units are disposed in each of the upper part and the lower part of a housing;

FIG. 21B is a diagram showing an image capturing device provided with total 12 environment map capturing units each having a field angle of 90 degrees;

FIG. 21C is a diagram showing an image capturing device in which environment map capturing units are disposed at corners of a housing;

FIGS. 22A and 22B are diagrams explaining a conventional art.

FIG. 22A is a diagram expressing a relationship between a virtual subject and an environment map in the conventional art, and

FIG. 22B is a diagram showing a result obtained by combining a virtual subject and a background image;

FIG. 23 is a hardware configuration diagram of a video editing apparatus in example 3;

FIG. 24 is an external view of a photo frame in example 3;

FIG. 25 is a diagram showing screen shots before and after subject combining position change on a video editing screen in example 3;

FIG. 26 is a functional block diagram of a video editing apparatus in example 3;

FIG. 27 is a diagram expressing light source parameter tables in example 3;

FIG. 28 is a diagram expressing combining position coordinate data in example 3;

FIG. 29 is a diagram expressing projection information data in example 3;

FIG. 30 is a processing flowchart of a video editing apparatus in example 3;

FIG. 31 is a flowchart of video editing processing in example 3;

FIG. 32 is a flowchart of light source parameter change processing in example 3;

FIG. 33 is a flowchart of lighting processing in example 3;

FIG. 34 is a flowchart of combining processing in example 3;

FIG. 35 is a diagram expressing a light source parameter table in example 4;

FIG. 36 is a flowchart of a video editing apparatus in example 4;

FIG. 37 is a flowchart of video editing processing in example 4;

FIG. 38 is a flowchart of light source parameter change processing in example 4;

FIG. 39 is a flowchart of video editing processing in example 5;

FIG. 40 is a flowchart of preparatory processing in example 6;

FIGS. 41A and 41B are diagrams expressing light source parameter tables in example 6; and

FIG. 42 is a flowchart of video editing processing in example 6.

### DESCRIPTION OF THE EMBODIMENTS

Hereinafter, with reference to the drawings, the present invention will be explained in detail by the use of preferable embodiments thereof. Note that configurations shown in the following embodiments are only examples and the present invention is not limited to the illustrated configurations.

### Example 1

### Conventional Art

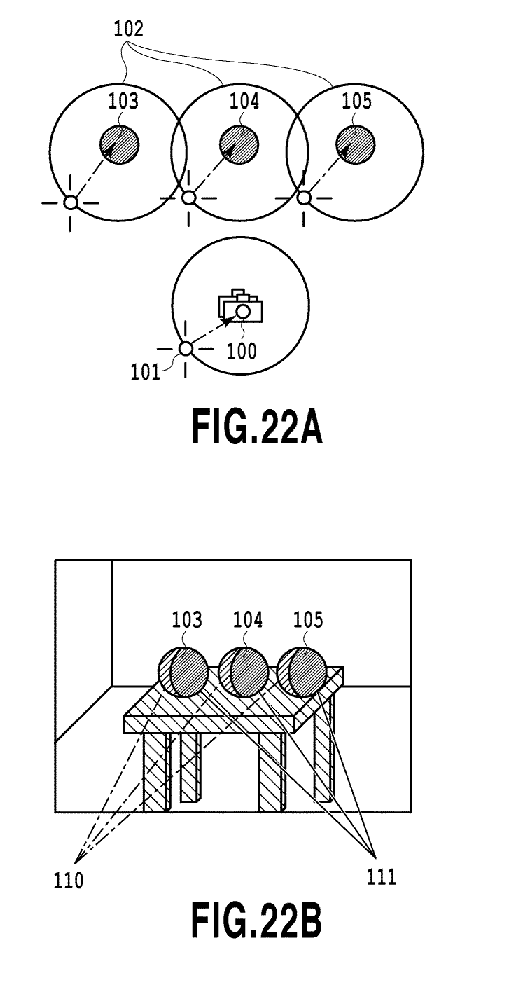

FIG. 22A is a diagram expressing a relationship between a virtual subject and an environment map in a conventional art. FIG. 22A shows a state in which an image of surrounding environment is captured by the use of an image capturing device 100 under an environment having a light 101, and an environment map 102 is generated to be used for lighting of virtual subjects 103 to 105. Since the same environment map is used for any virtual subject, the direction of the light 101 becomes equal wherever the virtual subject is disposed. In this situation, with the position of a virtual camera as a viewpoint, a result obtained by combing the virtual subjects 103 to 105 with a background image is FIG. 22B. It is found that the same shade is obtained for any of the virtual subjects 103 to 105 (a region 110 illuminated by the light 101 and a shade part 111 thereof are the same for all the virtual subjects). As far as the light source is not disposed at an infinite distance, such a shade is not caused in a real case, and thus an unnatural combined image is generated.

By the method according to the present example, natural lighting corresponding to the arrangement of the virtual subject is realized. Hereinafter, detailed explanation will be provided.

### <System Configuration Example>

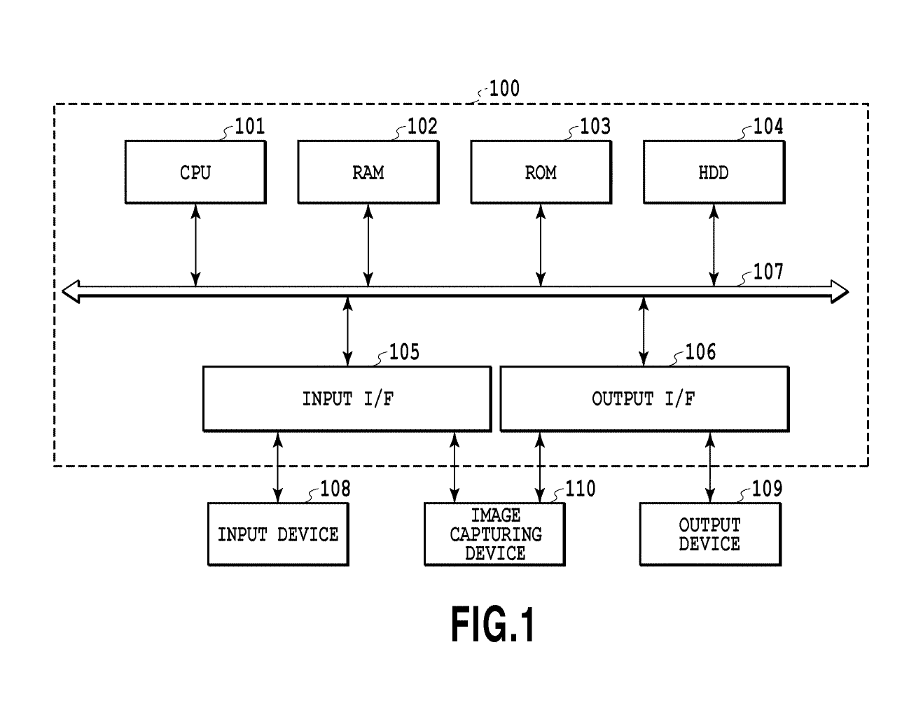

FIG. 1 is a diagram showing a system configuration example of an image processing apparatus according to the present example.

The image processing apparatus 100 includes CPU 101, RAM 102, ROM 103, HDD 104, input I/F 105, output I/F 106, and system bus 107. An outline of processing in the image processing apparatus 100 is as follows.

The CPU 101 executes programs stored in the ROM 103 and HDD 104 by using the RAM 102 as a work memory, and controls each unit to be described below via the system bus 107. Thereby, various kinds of processing are executed as described below.

The CPU 101 can control an image capturing device 110 via the output interface (I/F) 106, to perform image capturing. Furthermore, the CPU 101 can read in image data captured by the image capturing device 110 via the input interface (I/F) 105.

The CPU 101 can read out data from the HDD 104 and write in data to the HDD 104. Moreover, the CPU 101 can develop the data stored in the HDD 104 to the RAM 102, and similarly store the data developed in the RAM 102 into the HDD 104. Then, the CPU 101 assumes the data developed in the RAM 102 as a program and can execute the program.

The input I/F 105 is a serial bus interface such as, for example, USB and IEEE 1394, which connects an input device 108 such as a keyboard and a mouse. The CPU 101 can read in data from the input device 108 via the input I/F 105.

The output I/F 106 connects an output device 109 such as a display device. The output I/F 106 is a video image output interface such as, for example, DVI and HDMI. The CPU 101 can send data to the output device 109 via the output I/F 106 to execute displaying.

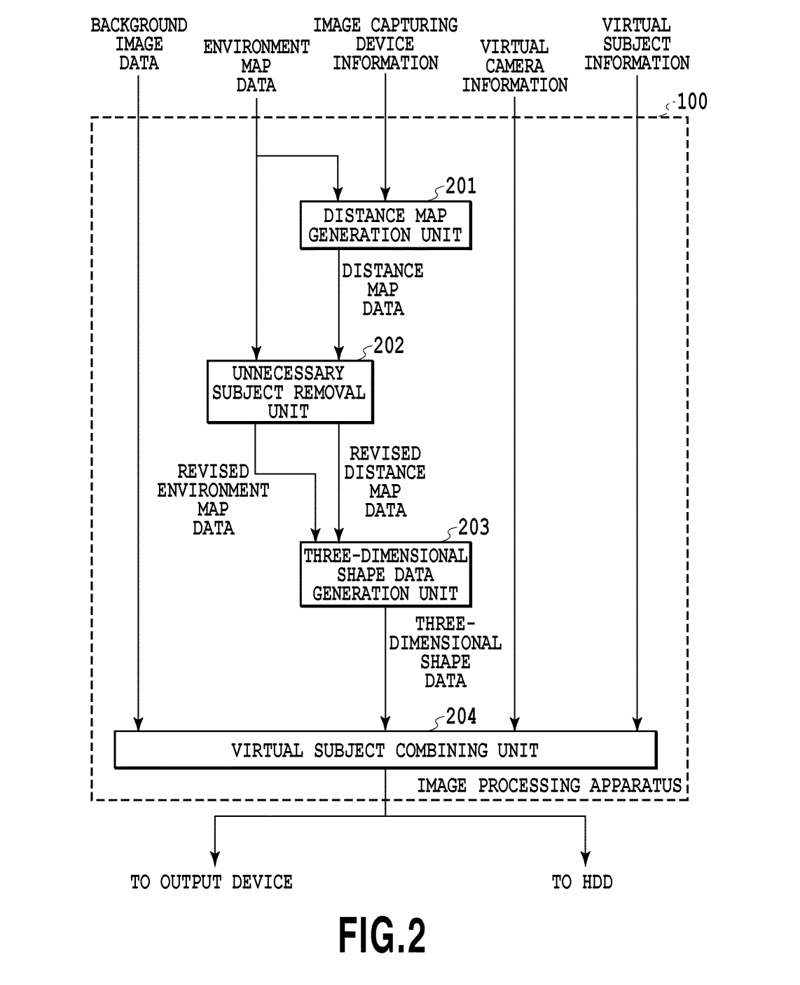

FIG. 2 is a functional configuration diagram of the image processing apparatus according to the present example. The configuration shown in this FIG. 2 is realized as image processing application software. That is, the CPU 101 causes the various kinds of software (computer program) stored in the HDD 104 and the like to operate, and thus the above configuration is realized.

The image processing apparatus 100 receives various kinds of data such as a background image, an environment map, image capturing device information, virtual camera information, and virtual subject information, and executes distance map generation, unnecessary subject removal, and surrounding environment three-dimensional shape data generation. Then, the image processing apparatus 100 outputs combined image data combining a virtual subject with a background image as output data. Here, the image capturing device information is information regarding the image capturing device 110 and includes lens data of an environment map capturing unit to be described below, information regarding a distance between the environment map capturing units, and the like. The virtual camera information is information of a virtual camera disposed in a virtual space and includes the direction of the virtual camera, a field angle, and the like other than three-dimensional coordinates (positional information) indicating the position of the virtual camera. The virtual subject information is data indicating details of the virtual subject to be combined with the background image and includes positional data specifying at least shape data of the virtual subject and a position where the virtual subject is disposed. Obviously, there are included information regarding color data and a reflectivity property to be used for reproducing the virtual subject preferably, and the like.

The various kinds of data such as the background image, environment map, capturing device information, virtual camera information, and virtual subject information are input from the image capturing device 110, the HDD 104, an external memory, or the like according to a user's instruction from the input device 108.

A distance map generation unit 201 estimates distances in all the directions by stereo-matching on the basis of the input environment map data and image capturing device information, and performs processing of generating distance map data.

An unnecessary subject removal unit 202 performs processing of removing an unnecessary subject on the input environment map data and distance map data. Note that the revised environment map and revised distance map, generated by this unnecessary subject removal processing, are referred to as a “revised environment map” and “revised distance map”, respectively.

A three-dimensional shape data generation unit 203 generates surrounding environment three-dimensional shape data on the basis of the input revised environment map data and revised distance map data. The three-dimensional shape data includes NURBS format data, for example, polygon data. Hereinafter, the present example will explain a case of the polygon data as an example.

A virtual subject combining unit 204 combines the virtual subject with the background image data on the basis of the background image, the surrounding environment three-dimensional shape data, the virtual camera information, and the virtual subject information. The generated combined image data is output to the output device 109 or stored into the HDD 104.

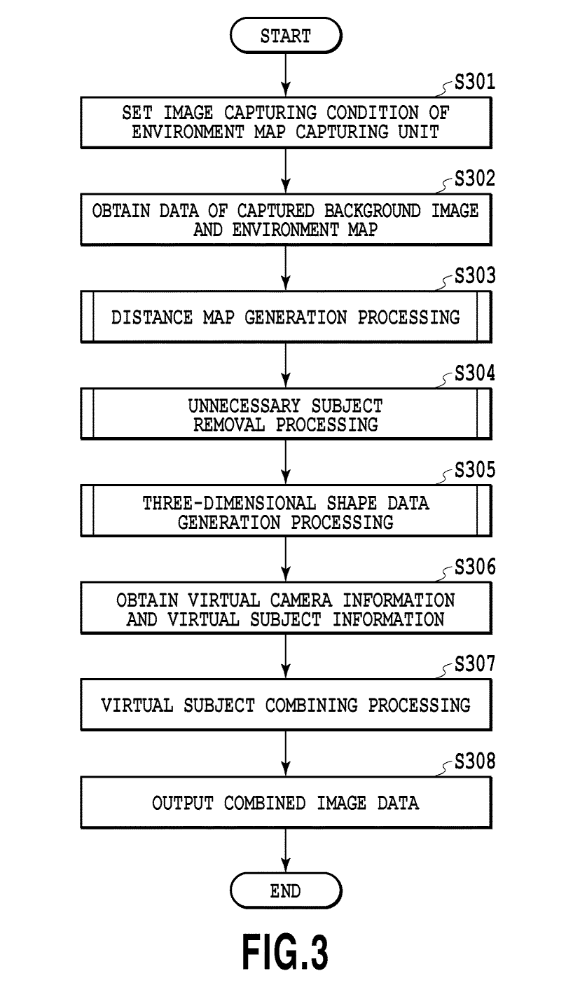

FIG. 3 is a flowchart showing the whole flow of the image processing executed in the image processing apparatus 100 according to the present example. Actually, after having read in, onto the RAM 102 from the ROM 103 or the like, a computer executable program describing the following sequence, the CPU 101 executes the program to thereby carry out the processing.

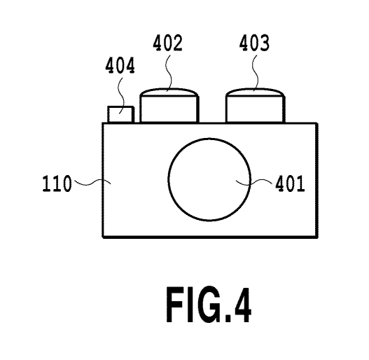

In step 301, the image processing apparatus 100 obtains setting contents (image capturing condition) on a background image capturing unit in the image capturing device 110, and sets the contents as an image capturing condition of the environment map capturing unit. The reason is to make it difficult to generate uncomfortable feeling in the case where the images are combined. For example, in the case where the environment map is dark compared with the background image, lighting to the virtual subject becomes dark and lightness balance is not obtained between the virtual subject and the background image. In order to avoid this problem, the image capturing condition is set so as to cause the background image and the environment map to be captured at the same exposure. FIG. 4 is an external view of the image capturing device 110 according to the present example for capturing the background image and the environment map. The image capturing device 110 includes three image capturing units 401, 402, and 403 for capturing color images and an image capturing button 404. The image capturing unit 401 among the three image capturing units is a background image capturing unit, and the image capturing units 402 and 403 are environment map capturing units. The environment map capturing units 402 and 403 have the up-down axes, left-right axes, and optical axes in the respective same directions, and are disposed upward in the upper part of a housing. The reason why the two environment map capturing units exist is to calculate a distance from the image capturing device in the captured environment map, and each of the environment map capturing units 402 and 403 is provided with an ultra-wide angle lens having a field angle of 180 degrees or more. The present step obtains image capturing conditions such as ISO sensitivity, exposure time, and an aperture value, set for the background image capturing unit 401, and sets image capturing conditions having the same contents, to the environment map capturing units 402 and 403. Note that the present step may be omitted and the lightness values or the like in both of the images captured at different exposures may be adjusted manually after the image capturing.

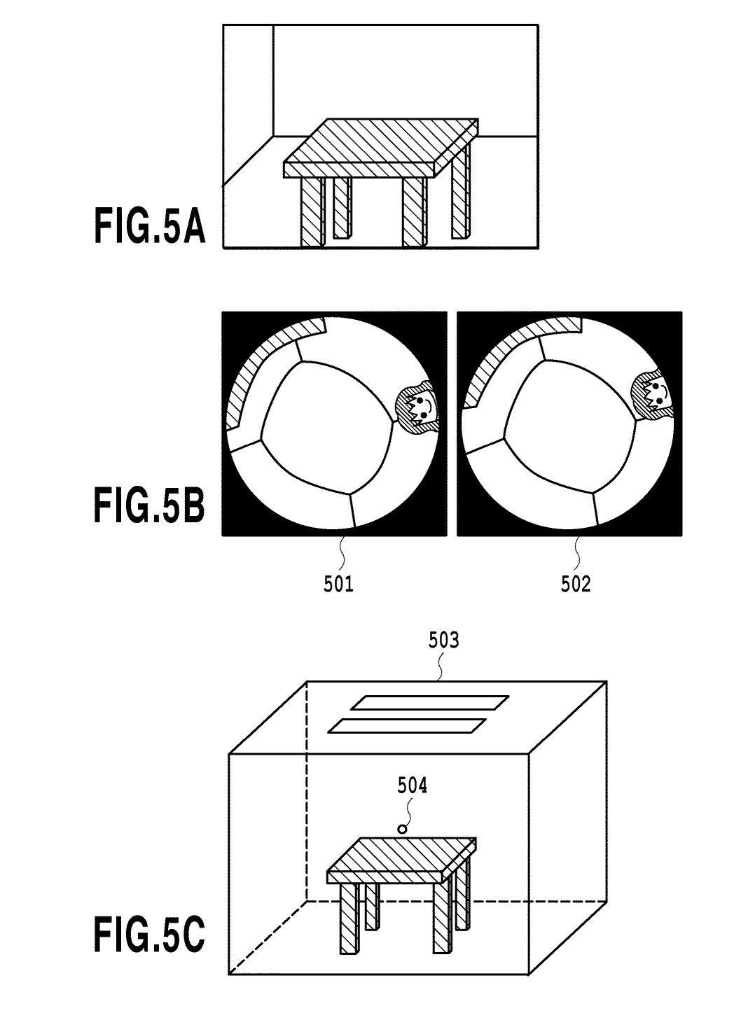

In step 302, the image processing apparatus 100 instructs the image capturing device 110 to perform image capturing and obtains the captured background image and environment map data. FIG. 5A and FIG. 5B show an example of the background image obtained in the present step and an example of the environment map obtained in the present step, respectively. FIG. 5C is a diagram showing an image capturing state of the environment map of FIG. 5B and shows that the image capturing has been performed from the center position 504 of a room in a real space 503.

In FIG. 5B, reference numeral 501 indicates the environment map captured by the environmental capturing unit 402 and reference numeral 502 indicates the environment map captured by the environment map capturing unit 403. The obtained background image data is sent to the virtual subject combining unit 204 and the environmental map data is sent to the distance map generation unit 201 and the unnecessary subject removal unit 202.

In step 303, the distance map generation unit 201 generates distance map data using the obtained environment map data. Details of the distance map generation processing will be described below.

In step 304, the unnecessary subject removal unit 202 provides unnecessary subject removal processing for the environment map data and the distance map data, and generates the revised environment map data and the revised distance map data. Details of the unnecessary subject removal processing will be described below.

In step 305, the three-dimensional shape data generation unit 203 generates the surrounding environment three-dimensional shape data (polygon data in the present example). Details of the surrounding environmental three-dimensional shape data generation processing will be described below.

In step 306, the image processing apparatus 100 obtains the virtual camera information and the virtual subject information. The obtained virtual camera information and virtual subject information is sent to the virtual subject combining unit 204.

In step 307, the virtual subject combining unit 204 performs the virtual subject combining processing for combining the background image data and the virtual subject to generate the combined image data. Details of the virtual subject combining processing will be described below.

In step 308, the image processing apparatus 100 outputs the generated combined image data to the output device 109 or the HDD 104.

### <Distance Map Generation Processing>

The distance map generation unit 201 calculates a distance from the image capturing device 110 (more precisely, optical center of the environment map capturing unit 402 or 403) to a surrounding environment (image capturing target) to generate the distance map data.

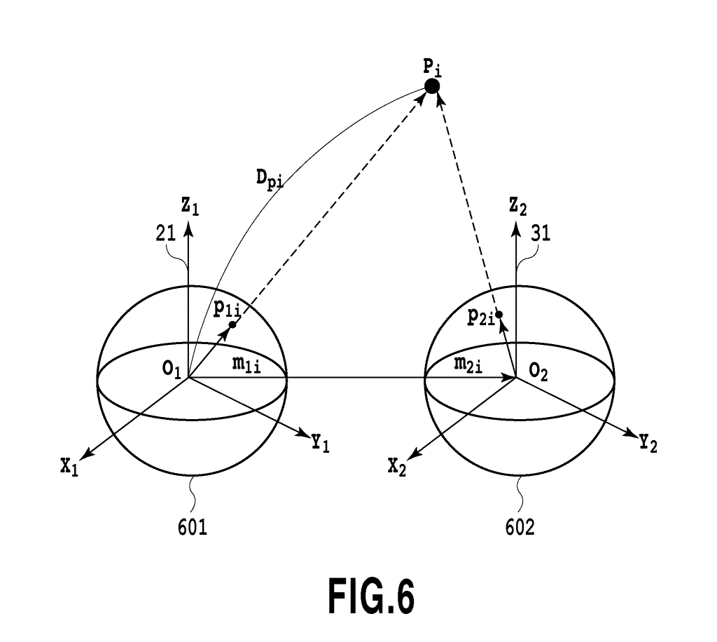

A method disclosed in, for example, Japanese Patent Laid-Open No. 2005-275789 can be applied to the distance calculation here. FIG. 6 is a diagram explaining a distance calculation method in the case where the three-dimensional structure extraction method according to Japanese Patent Laid-Open No. 2005-275789 is applied. Two spherical images 601 and 602 in FIG. 6 correspond to the environment maps 501 and 502, respectively. Note that the lower halves of the spherical images 601 and 602 can be obtained by assuming certain symmetric distances from the centers on the basis of the environment maps 501 and 502 which correspond to the upper halves of the spherical images, for example. A first coordinate system 21 expressing the spherical image 601 is shown by x₁ axis, y₁ axis, and z₁ axis and a second coordinate system 31 expressing the spherical image 602 is shown by x₂ axis, y₂ axis, and z₃ axis. An origin O₁ corresponds to an optical center of the environment map capturing unit 402 which captures the environment map 501 and an origin O₂ corresponds to an optical center of the environment map capturing unit 403 which captures the environment map 502. A subject point Pᵢ on an image capturing target appears as subject point images p₁ᵢ and p₂ᵢ on the surfaces of the two spherical images. Here, a positional vector of the subject point Pᵢ in the first coordinate system 21 is set to m₁ᵢ and a positional vector of the subject point Pᵢ in the second coordinate system 31 is set to m₂ᵢ. Furthermore, a rotation matrix for conversion from the second coordinate system 31 to the first coordinate system 21 is set to R and a translation vector for conversion from the first coordinate system 21 to the second coordinate system 31 is set to t. Then, a distance Dₚᵢ from the origin O₁ to each subject point Pᵢ of the image capturing target can be obtained by following formula (1).

$$\begin{matrix}[ Expression 1 ] & \\ Dpi = \frac{‖ t \times {m}_{2 i} ‖}{‖ {Rm}_{li} \times {m}_{2 i} ‖} & Expression ( 1 )\end{matrix}$$

In this manner, a distance to the image capturing target is calculated.

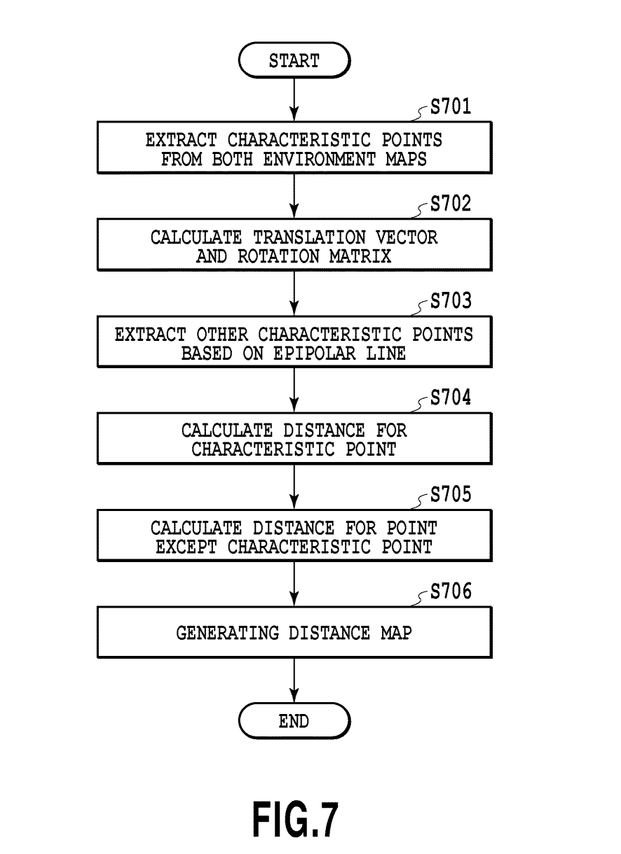

Note that, while a case where the environment map 501 is used as a reference will be explained in the explanation of the following flowchart of FIG. 7, the environment map 502 may be used as the reference. In this case, in the unnecessary subject removal processing to be described below, the unnecessary subject is removed from the environment map 502. Furthermore, also in the surrounding environment three-dimensional shape data generation processing, an image in which an unnecessary subject is removed from the environment map 502 is used.

FIG. 7 is a flowchart showing a flow of the distance map generation processing.

In step 701, the distance map generation unit 201 extracts characteristic points (p₁ᵢ and p₂ᵢ in FIG. 6) corresponding to each other in the environment map 501 and the environment map 502.

In step 702, the distance map generation unit 201 calculates the translation vector t and the rotation matrix R from the positional vectors m₁ₙ and m₂ₙ corresponding to the extracted characteristic points in the environment maps 501 and 502. Note that n indicates the number of characteristic points.

In step 703, the distance map generation unit 201 extracts other characteristic points corresponding to each other in the environment maps 501 and 502 on the basis of an epipolar line by using the translation vector t and the rotation matrix R.

In step 704, the distance map generation unit 201 substitutes, into formula 1, the positional vectors m₁ₙ and m₂ₙ corresponding to the extracted characteristic points, and calculates a three-dimensional position of the subject point Pᵢₙ corresponding to the characteristic points. That is, the distance map generation unit 201 calculates a distance Dₚᵢ of the subject point Pᵢₙ from the origin O₁ in the coordinate system 21. Thereby, a distance for the characteristic point is calculated.

In step 705, the distance map generation unit 201 calculates a distance from the origin O₁ for a pixel which has not been extracted as the characteristic point. Specifically, for a pixel which has not been extracted as the characteristic point among pixels in the environment map 501, the distance map generation unit 201 obtains a value from the characteristic points around the pixel by interpolation and uses the obtained value as a distance value of the pixel. A known method such as linear interpolation and bicubic interpolation may be used for the interpolation processing.

In step 706, the distance map generation unit 201 generates the distance map data which maps distance values of the pixels in the environment map 501.

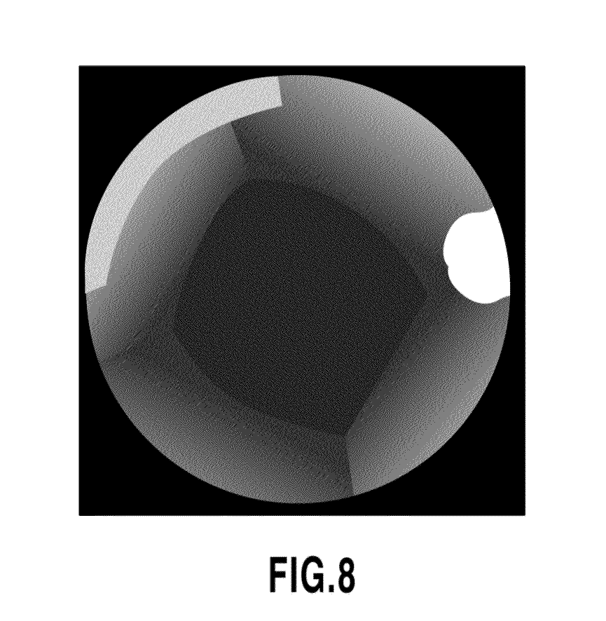

FIG. 8 is a diagram showing an example of the distance map which is generated in the distance map generation unit 201. Among the pixels in the environment map 501, a pixel at a shorter distance from the environment map capturing unit 402 has a higher pixel value and is expressed by a color closer to white and a pixel at a longer distance has a lower pixel value and is expressed by a color closer to black.

As described above, there is generated the distance map data expressing a distance of each pixel in the environment map, from the optical center of the image capturing device 110. The generated distance map data is sent to the unnecessary subject removal unit 202.

### <Unnecessary Subject Removal Processing>

In performing the image capturing, a photographer captures the background image and the environment map by using the image capturing device 110 as shown in FIG. 4. The environment map is an ultra-wide angle image having a field angle of 180 degrees or more and it is highly likely that an unintended subject is taken in. For example, there is a case where the photographer's own face or the hand holding a camera is captured into the environment map or a case that a person accidentally passing by is captured. If such an environment map is used as it is for lighting of the virtual subject, in the case where the virtual subject is a material accompanied by a ghost, for example, an unintended subject is drawn in a combined image. In order to prevent an unintended subject from affecting the lighting of the virtual subject, in the present example, processing of removing an unnecessary subject from the environment map data is performed. Furthermore, the unnecessary subject is removed together also from the distance map data. The present example introduces two kinds of method for the unnecessary subject removal processing.

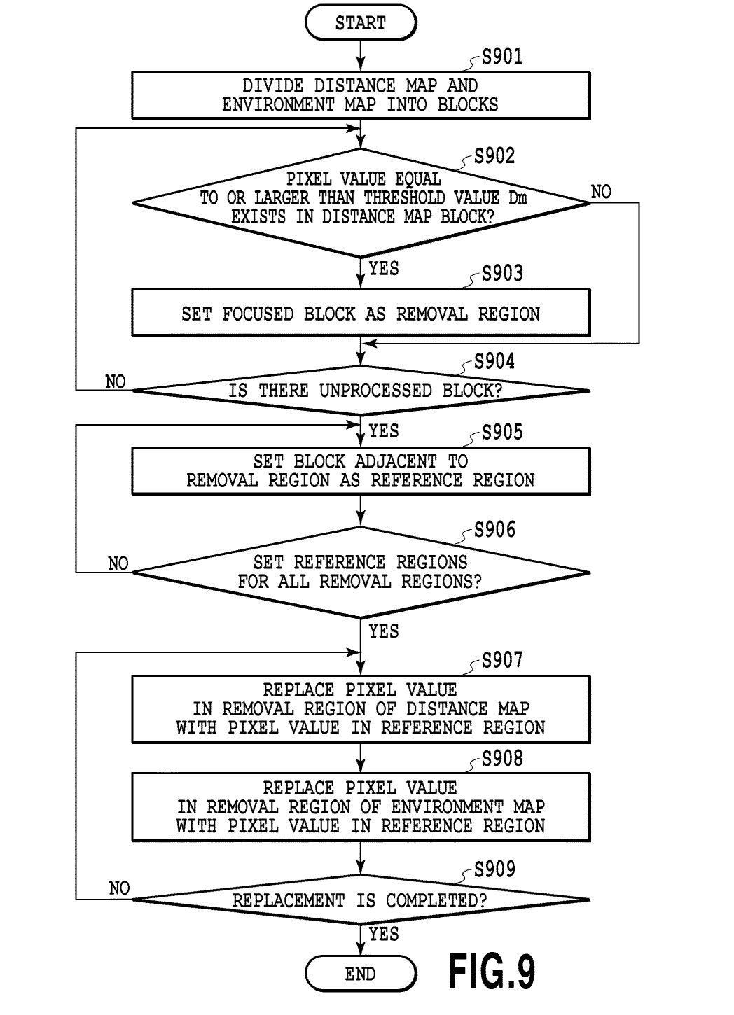

First, a method of removing a proximity subject such as a hand holding a camera will be explained. FIG. 9 is a flowchart showing a flow of the unnecessary subject removal processing for removing the proximity subject.

In step 901, the unnecessary subject removal unit 202 divides the input environment map data and the distance map data received from the distance map generation unit 201 into blocks. The size in each of the divided blocks is 8×8 (pixels), for example.

In step 902, the unnecessary subject removal unit 202 determines whether a pixel having a pixel value of a predetermined threshold value Dm or larger exists or not in a predetermined divided block (focused block) in the distance map. If the pixel having a pixel value of the threshold value Dm or larger exists, the process goes to step 903. In contrast, if the pixel having a pixel value of the threshold value Dm or larger does not exists, the process goes to step 904.

In step 903, the unnecessary subject removal unit 202 sets the focused block as a region of the removal target (removal region).

In step 904, the unnecessary subject removal unit 202 determines whether the processing has been finished for all the blocks. If an unprocessed block exists, the process returns to step 902. If the processing has been finished for all the blocks, the process goes to step 905.

In step 905, the unnecessary subject removal unit 202 sets a block adjacent to the block set as the removal region as a reference region for setting a substitute pixel value after the unnecessary subject removal.

In step 906, the unnecessary subject removal unit 202 determines whether the reference region setting processing has been finished for all the blocks set as the removal region. If a removal region (block), for which the reference region has not been set, exists, the process returns to step 905. In contrast, if the reference region setting has been finished for all the removal regions, the process goes to step 907.

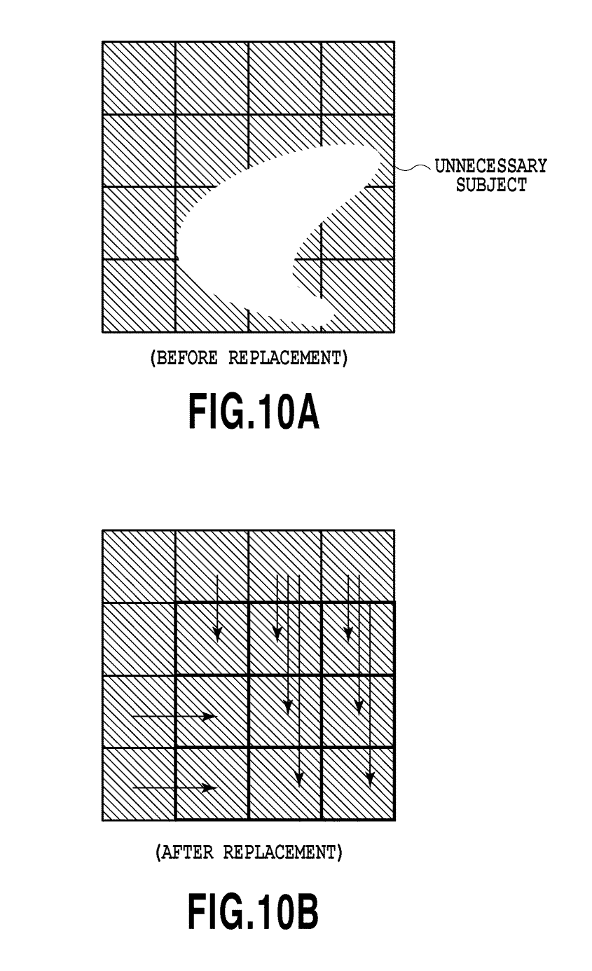

In step 907, for each of the blocks on the distance map, the unnecessary subject removal unit 202 replaces pixel values within the block set in the removal region with pixel values within the block set in the reference region. FIGS. 10A and 10B are diagrams showing a state in which the pixel values within the block set in the removal region on the distance map are replaced by the pixel values within the block set in the reference region. In the distance map after the replacement (FIG. 10B), the pixel values of the block where the unnecessary subject exists are replaced by the pixel values of the block where the unnecessary subject does not exist, and it is found that the unnecessary subject disappears.

In step 908, as in the case of the distance map, the unnecessary subject removal unit 202 performs the pixel value replacement processing on each corresponding block in the environment map.

In step 909, the unnecessary subject removal unit 202 determines whether the pixel value replacement processing has been completed for all the removal regions in the distance map and the environment map. If a removal region exists without having been provided with the replacement, the process returns to step 907. In contrast, if the replacement processing has been completed for all the removal regions, the present processing is finished.

Next, a method of removing a person such as a photographer by face recognition will be explained briefly.

In the case where a person is removed by the face recognition, first, a face region is extracted from the environment map. Specifically, by pattern matching with a face template, a region corresponding to the persons' face is extracted from the input environment map data. Other than this method, there is a method of extracting a flesh color component within an image and extracting a photometric point cluster determined to exist within a flesh color range as a face, or a method of converting photometric data into hue and chroma and generating and analyzing a two dimensional histogram thereof to determine a face region. Furthermore, other various methods can be applied, such as a method of extracting a face candidate region corresponding to a shape of a human face and determining a face region from a characteristic amount within the region, and a method of extracting a contour of a human face from an image to determine a face region.

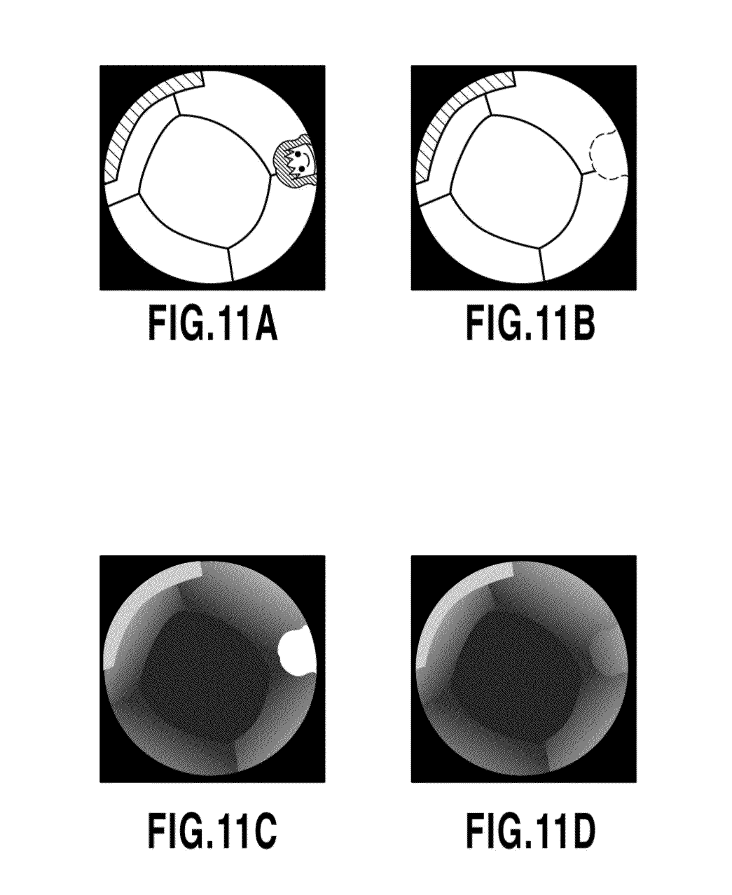

Then, the extracted face region is set as the removal region in the distance map and the environment map, and successively the pixel values are replaced by pixel values in the adjacent region thereof as in the case of the flow of above FIG. 9. FIGS. 11A to 11D are diagrams showing examples of the environment map and distance map in each of which a person's face is removed by the unnecessary subject removal processing. FIG. 11A is an environment map in a state in which a human face is captured before the unnecessary subject removal, and FIG. 11C shows a distance map corresponding to the environment map. Then, FIG. 11B is an environment map in which the human face has been removed by the unnecessary subject removal processing. FIG. 11D shows a distance map corresponding to this environment map.

By the above processing, the revised environment map and the revised distance map, in which the unnecessary subjects have been removed from the environment map and the distance map, are generated.

### <Surrounding Environment Three-Dimensional Shape Data Generation Processing>

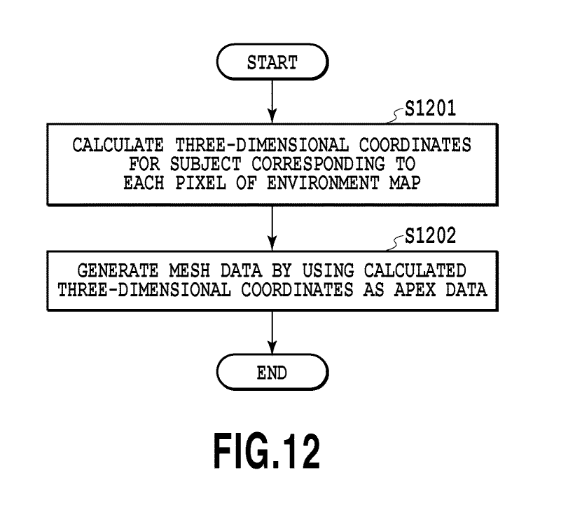

FIG. 12 is a flowchart showing a flow of the surrounding environment three-dimensional shape data generation processing in step 305 of FIG. 3.

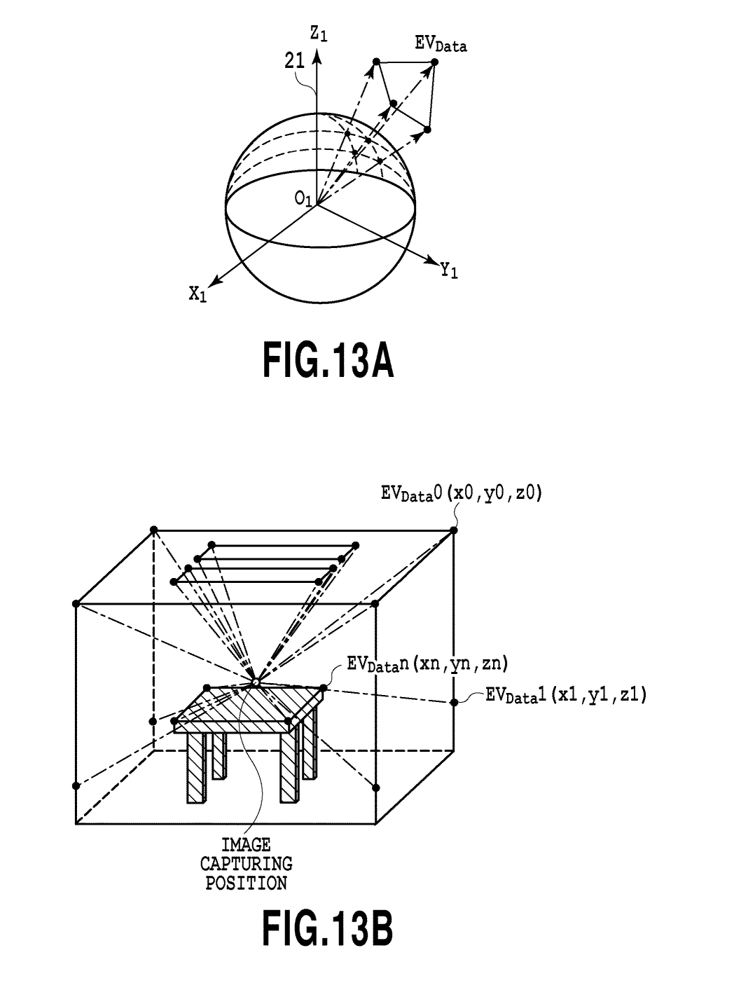

In step 1201, the three-dimensional shape data generation unit 203 calculates three-dimensional coordinates EV_{Data} of a subject corresponding to each of the pixels in the environment map from the environment map data and the distance map data. FIG. 13A is a diagram showing a relationship between the environment map and the three-dimensional coordinates EV_{Data}. In FIG. 13A, an origin O₁ is the optical center of the environment map capturing unit which captures the environment map as in FIG. 6. FIG. 13B shows the three-dimensional coordinates EV_{Data} in the environment map which is captured at the center of the room shown in FIG. 5C. The three-dimensional coordinates EV_{Data} form a three-dimensional coordinate group shown as black dots in FIG. 13B and is treated in a format that X, Y, and Z coordinates of each point are described sequentially, for example.

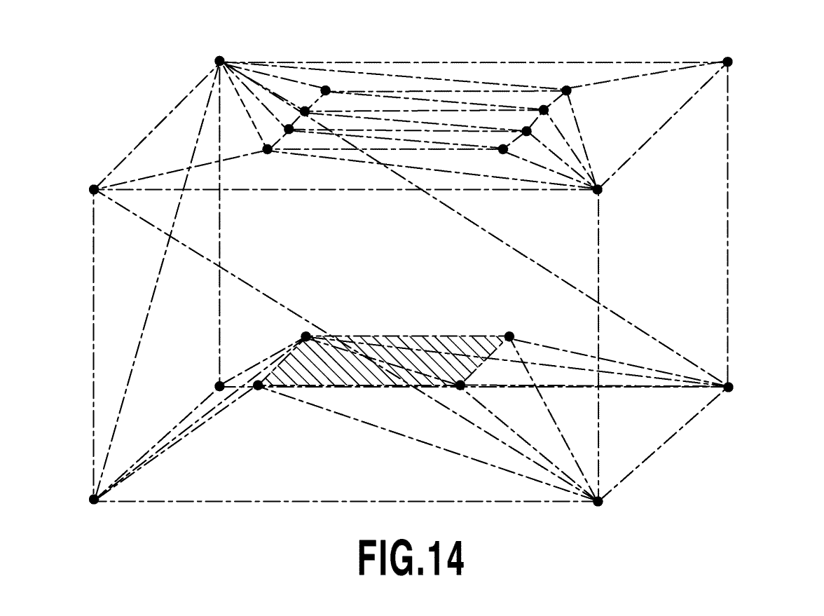

In step 1202, the three-dimensional shape data generation unit 203 generates the surrounding environment three-dimensional shape data (specifically, polygon data) using calculated EV_{Data} as apex data. For apexes, as shown in FIG. 13A, the apexes which corresponds to neighboring pixels on the environment map are connected with each other. For example, in the case of EV_{Data} shown in FIG. 13B, polygon data as sown in FIG. 14 is obtained. Here, color information of the apex is assumed to be a pixel value of the environment map.

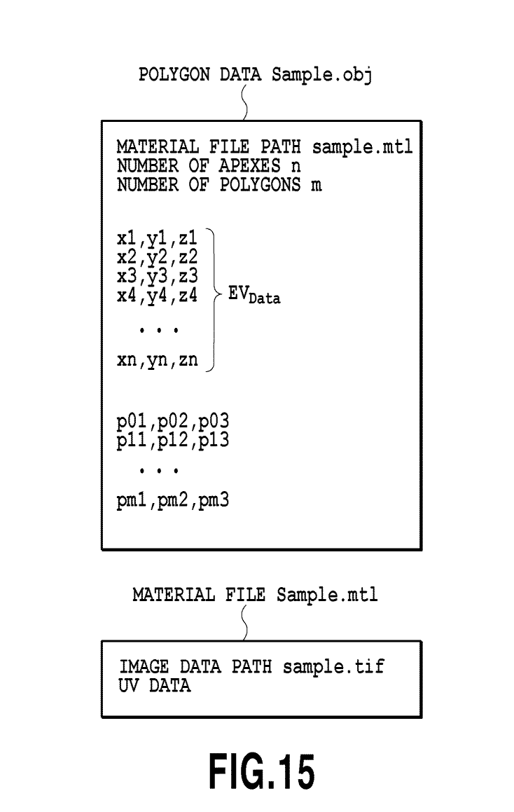

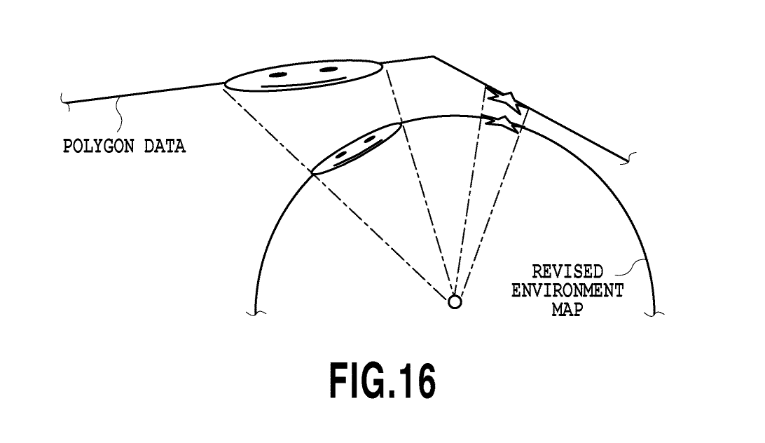

The polygon data generated in this manner is treated in a file format which is called OBJ format, for example, as shown in FIG. 15. The OBJ format is supported by many CG software products and widely used as an intermediate file format of CG software. The file description contents include a path to a material file designating the color of the shape, the number of apex data sets, the number of triangles (polygons), a coordinate value of each apex, that is, EV_{Data}, and a normal vector of each triangle (polygon). Here, the material file is a file designating a color for the polygon data. The color designated here is treated as the color of a light in the combining processing unit. The material file describes a path of image data pasted to the polygon data and UV data. FIG. 16 is a diagram showing a relationship therebetween. The revised environment map is designated to be copied to the polygon data and the UV data designates an optional position of a texture image in a polygon unit.

By the above processing, the surrounding environment polygon data for the image capturing device can be generated.

### <Virtual Subject Combining Processing>

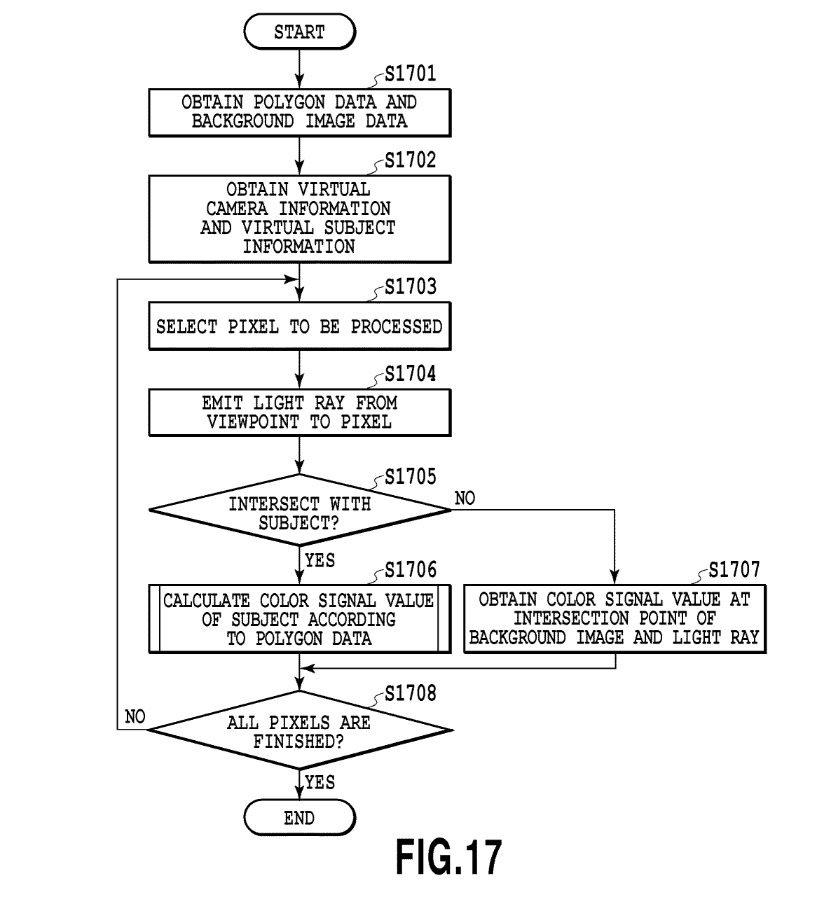

FIG. 17 is a flowchart showing a flow of the virtual subject combining processing in step 307 of FIG. 3. In this virtual subject combining processing, the surrounding environment three-dimensional shape data (polygon data) is used for lighting, instead of the environment map data.

In step 1701, the virtual subject combining unit 204 obtains the polygon data generated in the three-dimensional shape data generation unit 203 and the background image data captured in the background image capturing unit 401.

In step 1702, the virtual subject combining unit 204 obtains the virtual camera information and the virtual subject information.

In step 1703, the virtual subject combining unit 204 selects a pixel to be processed.

In step 1704, the virtual subject combining unit 204 sets, as a viewpoint, a point specified by the position and direction of the virtual camera which are included in the obtained virtual camera information, and emits a light ray from the viewpoint toward the selected to-be-processed pixel.

In step 1705, the virtual subject combining unit 204 determines whether the emitted light ray intersects with the virtual subject or not. In the case where the light ray intersects with the virtual subject, the process goes to step 1406. In contrast, in the case where the light ray does not intersect with the virtual subject, the process goes to step 1407.

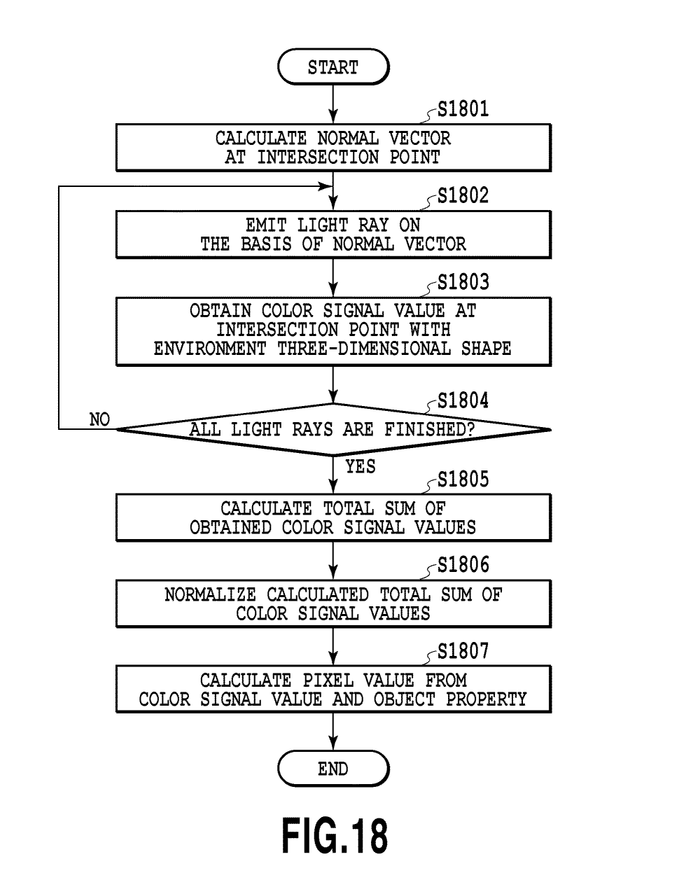

In step 1706, the virtual subject combining unit 204 calculates a color signal value of the virtual subject on the basis of the polygon data obtained in step 1401. FIG. 18 is a flowchart showing a flow for processing of calculating the color signal value of the virtual subject (object rendering processing).

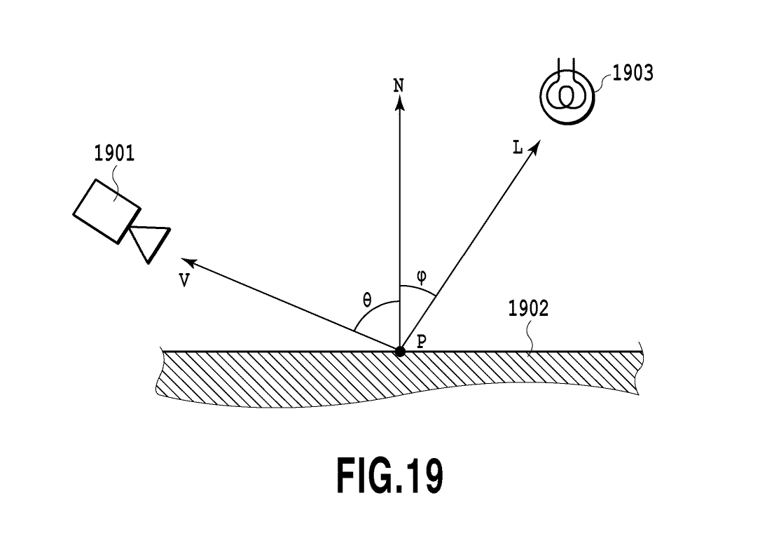

In step 1801, the virtual subject combining unit 204 obtains a normal vector at an intersection point of the light ray and the virtual subject. FIG. 19 is an exemplary diagram showing a relationship between the emitted light ray and the virtual subject. In FIG. 19, reference numeral 1901 indicates a viewpoint (virtual camera) for emitting a light ray, reference numeral 1902 indicates a virtual subject intersected by the light ray, and reference numeral 1903 indicates a light source illuminating the virtual subject. A normal vector N to be obtained is a vector vertical to the surface of the virtual subject at an intersection point between the light ray and the virtual subject.

In step 1802, the virtual subject combining unit 204 emits a light ray from the intersection point P toward the light source 1603 on the basis of the obtained normal vector N. Generally, it is possible to calculate the color signal value of a pixel more precisely when a larger number of light rays emitted from the intersection point P. Furthermore, the direction of the light ray to be emitted is determined in a range in which an angle φ between the normal vector N and a vector L of the light ray to be emitted is 90 degrees or smaller. Note that the light ray may be emitted, in a predetermined angle range, by being divided equally by the desired number of light rays, or the light rays may be emitted randomly.

In step 1803, the virtual subject combining unit 204 obtains a color signal value of an intersection point between the emitted light ray and the surrounding environment three-dimensional shape specified by the polygon data. That is, there is obtained a color signal value corresponding to a light ray hitting the surrounding environment three-dimensional shape as a light source.

In step 1804, the virtual subject combining unit 204 determines whether the obtaining of the color signal value of the intersection point with the surrounding environment three-dimensional shape has been finished or not for all the light rays. If the obtaining has been finished, the process goes to step 1805. In contrast, if the obtaining has not been finished, the process returns to step 1802 and the next light ray is emitted.

In step 1805, the virtual subject combining unit 204 calculates a total sum of the obtained color signal values. In the case where the color signal values obtained for each light ray are set to rᵢ, gᵢ, and bᵢ, and the number of light rays is set to n, the total sum (R_{ray}, G_{ray}, and B_{ray}) of a calculated color signal value is expressed by following formula (2).

$$\begin{matrix}[ Expression 2 ] & \\ {R}_{ray} = {\sum }_{i}^{n} {r}_{i} \\ {G}_{ray} = {\sum }_{i}^{n} {g}_{i} \\ {B}_{ray} = {\sum }_{i}^{n} {b}_{i} & Expression ( 2 )\end{matrix}$$

In step 1806, the virtual subject combining unit 204 normalize the calculated color signal value total sum. While originally the intensity of the light ray is obtained as a sum of the intensities of individual light rays, in the case where the number of emitted light rays is different among pixels or light ray hit points, it becomes difficult to keep a relative intensity relationship among the light rays. Furthermore, in the case where the number of light rays is increased, the intensity of the light ray cannot be reproduced in an output range of an output image (e.g., 256 gray levels for each R, G, and B component for an 8 bit image). Therefore, the obtained total sum of the color signal values is normalized. A desired method may be used for the normalization method. For example, normalized color signal values (Rₚ, Gₚ, and Bₚ) can be obtained by following formula (3).

$$\begin{matrix}[ Expression 3 ] & \\ {R}_{p} = \frac{{R}_{ray}}{n} \\ {G}_{p} = \frac{{G}_{ray}}{n} \\ {B}_{p} = \frac{{B}_{ray}}{n} & Expression ( 3 )\end{matrix}$$

In step 1807, the virtual subject combining unit 204 calculates a pixel value from the normalized color signal value and reflection properties of the subject. In the case where the reflection properties of the subject corresponding to the respective color signal components are set to R_{ref}, G_{ref}, and B_{ref}, pixel values to be obtained (Rₚᵢₓₑₗ, Gₚᵢₓₑₗ, and Bₚᵢₓₑₗ) are expressed by following formula (4).

[Expression 4]

Rₚᵢₓₑₗ=Rₚ×R_{ref}

Gₚᵢₓₑₗ=Gₚ×G_{ref}

Bₚᵢₓₑₗ=Bₚ×B_{ref} Expression (4)

In this manner, a color signal value of the virtual subject is calculated.

To return to explanation of the flowchart in FIG. 17.

In step 1707, the virtual subject combining unit 204 obtains an intersection point between the background image data obtained in step 1701 and the light ray emitted in step 1704, and obtains a color signal value at the intersection point.

In step 1708, the virtual subject combining unit 204 determines whether the color signal value calculation has been finished or not for all the pixels. If the calculation has been finished for all the pixels, the present processing is finished. If the calculation has not been finished for all the pixels, the process returns to step 1703 and the next pixel to be processed is selected.

As described above, the virtual subject combining processing is performed using the surrounding environment three-dimensional shape data as a light source.

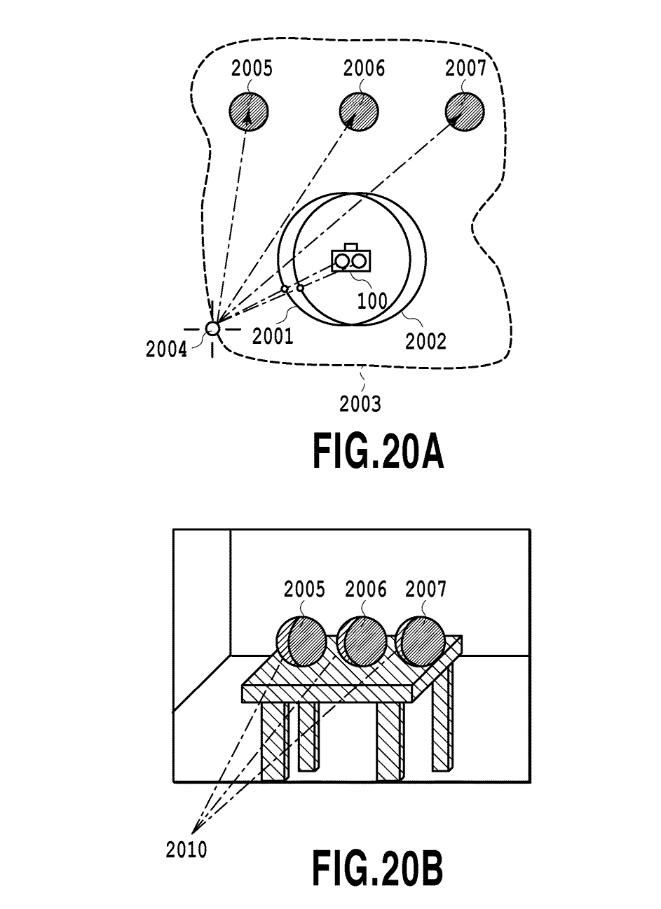

FIG. 20A is a diagram expressing a relationship between the surrounding environment three-dimensional shape used for the lighting in the present example and the virtual subject. In the case where environment maps 2001 and 2002 are obtained in the image capturing device 100, polygon data shown by a broken line 2003 is generated via the distance map generation processing and the surrounding environment three-dimensional shape data generation processing. Since the three-dimensional coordinates of a light 2004 are determined, a region illuminated by the light 2004 changes appropriately for each of virtual subjects 2005 to 2007. FIG. 20B shows an example of a combined image in which the virtual subject is combined with a background image by the method according to the present example. In comparison with FIG. 22B which is a conventional example, in FIG. 20B, there are provided appropriate shades 2010 corresponding to the respective positions of the virtual subjects 2005 to 2007, and thus it is found that a more natural combined image is obtained.

Note that, while the case of combining a still subject with a still image has been explained, the same effect can be obtained also in the case of combining a moving subject with a still image. For example, the environment map data of 30 frames is obtained in one second and the above processing may be performed for each of the frame. As a problem arising at this time, there is a case where the shape of the polygon data includes an error and deforms repeatedly along the temporal axis and thus lighting to a virtual subject blinks. Accordingly, it is effective to track the characteristic point along the time axis and perform smoothing processing on the three-dimensional coordinates EV_{Data}. Thereby, a natural combined image in which the shade changes in response to a positional change of the virtual subject can be obtained.

Note that, although, in the present example, there has been explained the case of combining the virtual subject with the background image through the use of the surrounding environment three-dimensional shape data, the combining with the background image is not essential. That is, by performing processing of calculating a color signal value of the virtual subject (object rendering processing) through the use of the surrounding environment three-dimensional shape data generated in the three-dimensional shape data generation unit 203, a configuration may be such that an image of only the virtual subject (virtual subject image) is generated.

In this case, only the polygon data may be obtained in step 1701 of the flowchart in FIG. 17, and, when it is determined that the emitted light ray does not intersect with the virtual subject in the intersection determination processing in step 1705, the process may go to step 1708. That is, the processing of calculating the color signal value may be performed only when the light ray emitted in step 1704 intersects with the virtual subject, and, when the emitted light ray does not intersect with the virtual subject, the process may be shifted to the processing of the next pixel.

As described above, according to the present example, in combining a virtual subject with actually captured background image data, it becomes possible to easily generate natural combined image data by using appropriate lighting corresponding to the position of the virtual subject.

### Example 2

Example 1 makes use of the image capturing device including background image capturing unit and two environment map capturing units. Next, there will be explained, as example 2, a mode in which an image capturing device including a larger number of environment map capturing units is used.

In the image capturing device 110 introduced in example 1, two environment map capturing units 402 and 403 are disposed in the upper part of the case. In this case, only the upper half part of the environment can be captured. If only the environment map captured by this image capturing device 110 is used as it is, lighting to the virtual subject is limited to lighting from above.

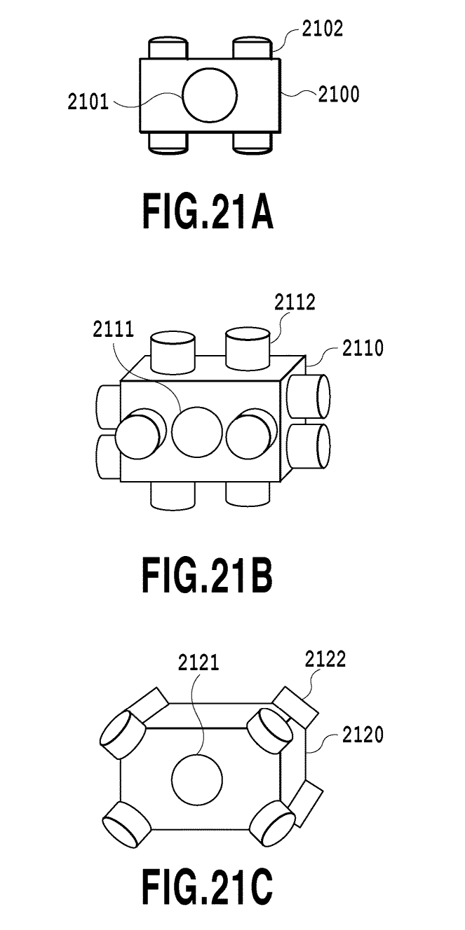

Through the use of an image capturing device including a larger number of environment map capturing units as shown in FIGS. 21A to 21C, a work of supplementing the lower half environment becomes unnecessary by assuming a certain distance as explained in example 1.

FIG. 21A shows an image capturing device 2100 in which two environment map capturing units 2102 are disposed for each of the upper part and the lower part of a housing other than a background image capturing unit 2101. By generating the distance map and the polygon data using the environment map image data captured by the environment map capturing units 2102 provided in the lower part of the housing, it becomes possible to build an accurate lighting environment from below the virtual subject.

FIG. 21B shows an image capturing device 2110 including 12 environment map capturing units 2112 each having a field angle of 90 degrees besides a background image capturing unit 2111. In the case of the image capturing device 2110, two environment map capturing units 2112 are disposed in a pair for each of six directions of a housing; up-down, left-right, and front-rear directions. The up-down axes, left-right axes, and optical axes for the pair of image capturing units are arranged in the same directions.

FIG. 21C shows an image capturing device 2120 in which environment map capturing units 2122 are disposed at corners of a housing besides a background image capturing unit 2121. In this case, it is possible to generate the polygon data similarly by calculating a surrounding distance through the use of images in which image capturing regions overlaps each other, in image data obtained from the environment map capturing units 2122.

### Example 3

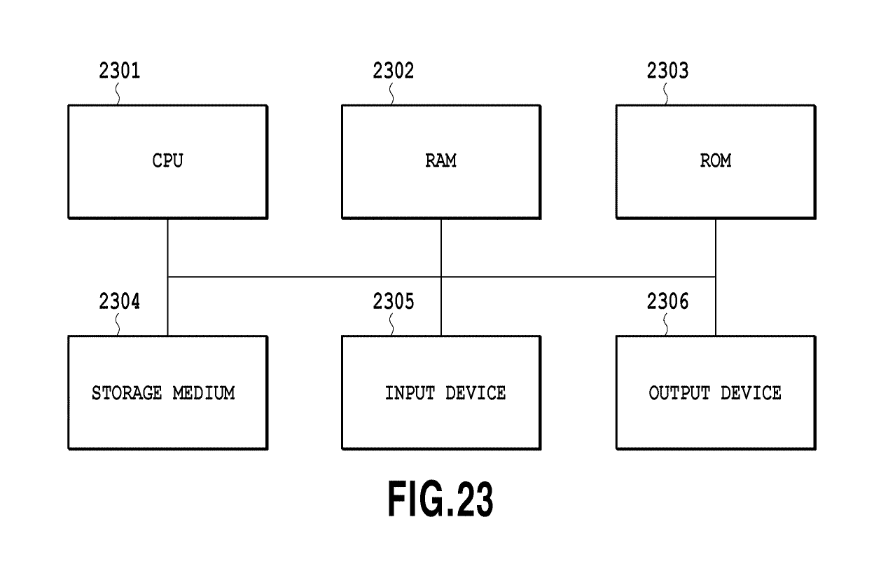

FIG. 23 shows a hardware configuration diagram for realizing the present embodiment. A CPU 2301 is involved in processing of all the constituents, and reads in instructions stored in a ROM 2302 and a RAM 2303 sequentially, interprets the instruction, and executes the processing in accordance with a result thereof. Furthermore, the ROM 2302 and the RAM 2303 provide the CPU 101 with a program, data, a work area, and the like that are necessary for the processing. A storage medium 104 is a storage medium (or device) storing image data and the like, such as a hard disk, CF card, SD card, USB memory, and memory card, for example. An input device 2305 is an input device such as a touch screen, keyboard, mouse, and receives an instruction from a user. An output device 2306 in which a liquid crystal display is widely used performs image and character display. Furthermore, the output device 2306 may include a touch panel function, and, in this case, can be used also as the input device 2305.

In the present embodiment, an example applied to a photo frame will be explained as a mode of the above video editing apparatus.

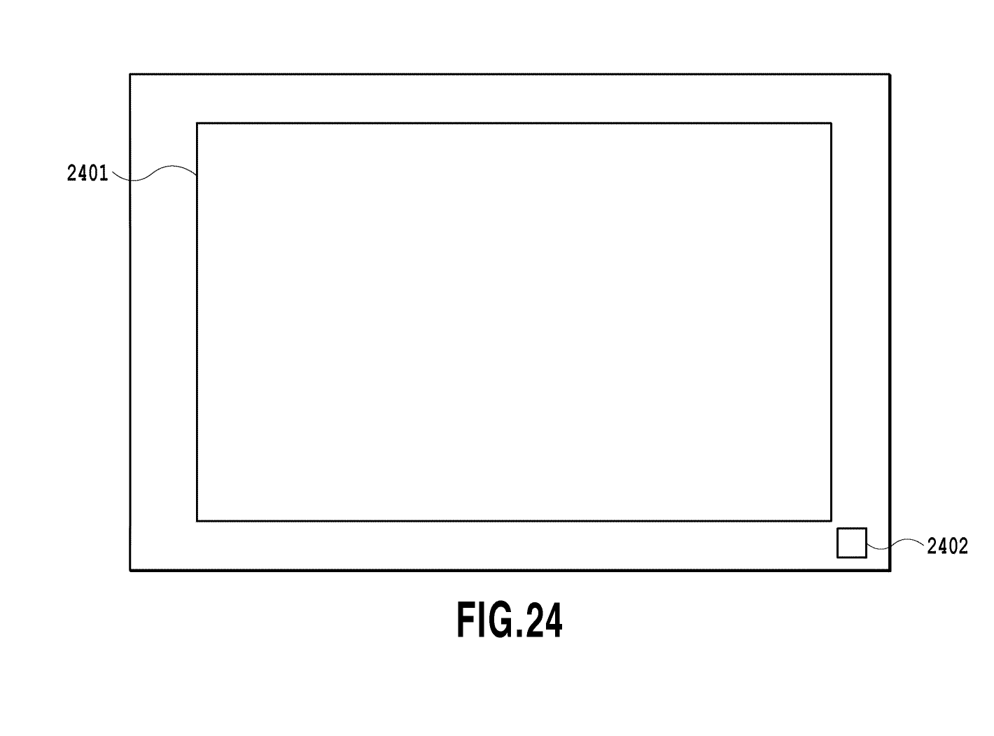

FIG. 24 is a front view of a photo frame which is a video processing apparatus of the present embodiment. A touch screen display 2401 is a display for displaying an image and also an input device receiving input from the user. This touch screen display 2401 corresponds to the output device 2306 and the input device 2305 in FIG. 23 and can detects plural input coordinates individually at the same time. Reference numeral 2402 indicates a power supply button.

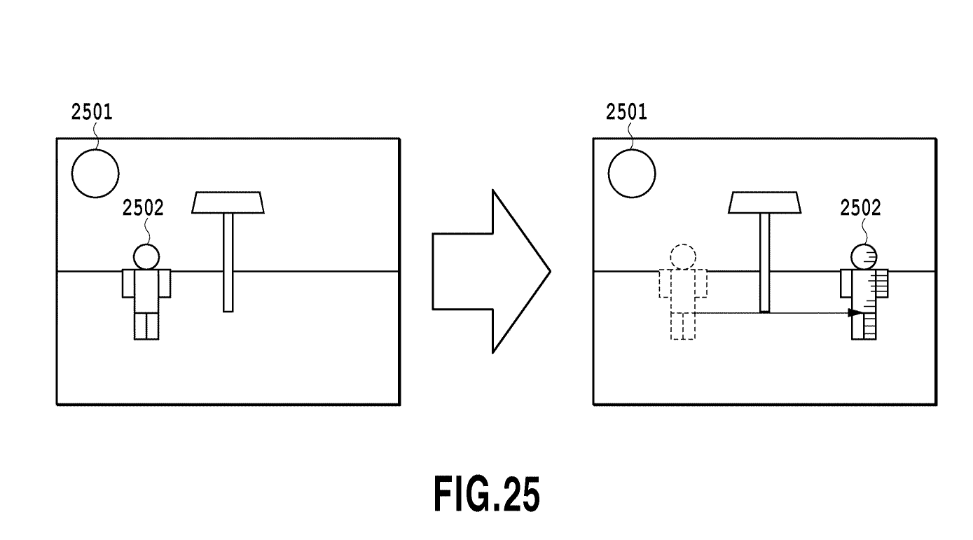

FIG. 25 shows screen shots before and after subject combining position change on a video editing screen in the present embodiment. Reference numerals 2501, and 2502 indicate a background image and a combined foreground image, respectively. The background image and the foreground image are distinguished from each other and many images thereof are stored in the storage medium 104, and the illustrated background image 2501 and foreground image 2502 are designated by the user therefrom. An α value (transparency) is attached to the foreground image and a desired subject is cut out. In the present embodiment, the foreground image 2502 is a moving image, and the subject moves and the combining position thereof changes in the case where the image is reproduced. Along with the change of the combining position, a lighting effect corresponding to the combining position is provided for the foreground image 2502. Note that, while the foreground image is a moving image and the combining position changes here, this is an example and the present embodiment is not limited to this case. For example, the combining position may be changed by user's dragging of the foreground image. Furthermore, according to user's operation, scale change of the foreground image and transfer or scale change of the background image may be performed.

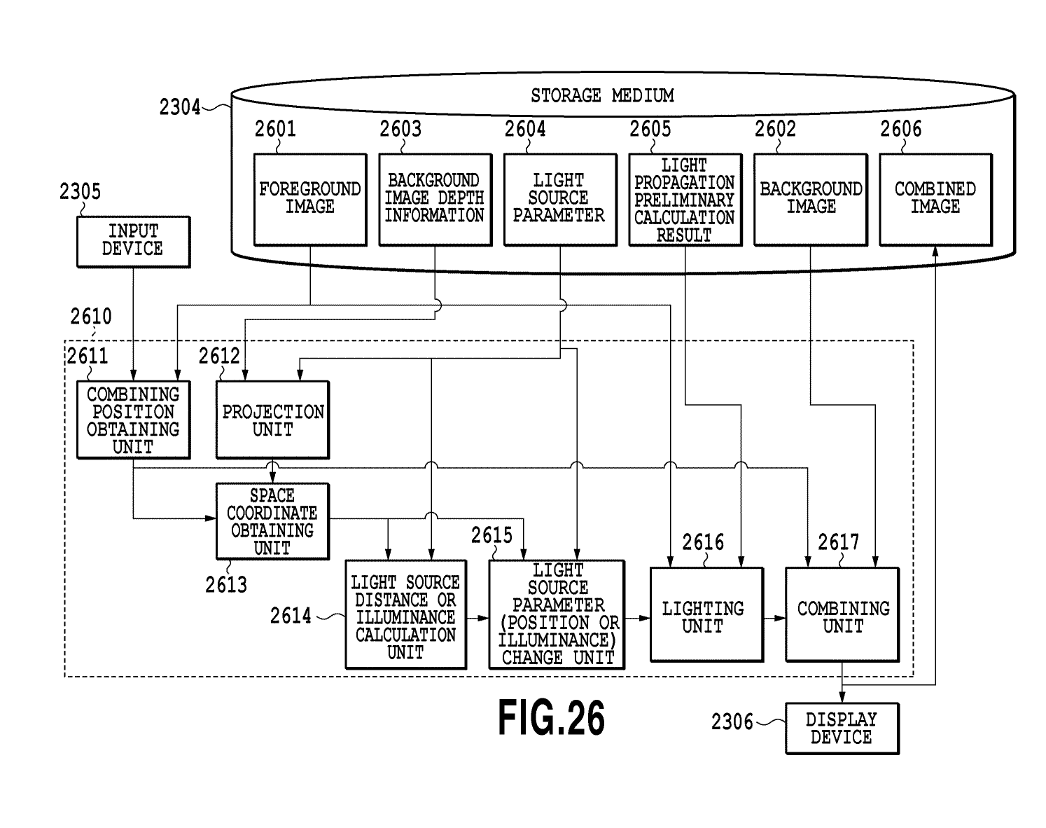

FIG. 26 shows a functional block diagram of the apparatus of the present embodiment. In the illustration, reference numeral 2601 indicates a foreground image. Reference numeral 2602 indicates a background image. Reference numeral 2603 indicates background image depth information which expresses the depth of each pixel in the background image 2602. The depth information has an image format having the same resolution as that of the background image 2602 and the depth information is added to the RGB components of each pixel. Furthermore, the background image is captured as a stereo image and the background image depth information is generated by the use of a stereo matching method. Note that to generate the depth information by the use of the stereo matching method is an example and the present embodiment is not limited to this case. For example, a straight line and a disappearing point in the background image are detected and the depth information may be estimated. Furthermore, the user may designate the depth information. Reference numeral 2604 indicates a light source parameter expressing position information or illuminance information of the light source viewed from a position where the background image is captured. The position information of the light source is obtained by a method of generating an all surrounding image of the position where the background image is captured and the depth information thereof, by the use of a technique disclosed in Japanese Patent Laid-Open No. 2010-181826 or the like. For the illuminance information of the light source, an all surrounding image of the position where the background image is captured as an HDR image and a brightness value of the image is obtained as the illuminance information. Note that these are examples and the present embodiment is not limited to these cases. For example, the position information of the light source may be designated by the user or the position information to the light source may be obtained by the use of a distance measuring sensor. Furthermore, the illuminance information of the light source may be designated by the user or measured by an illuminance meter.

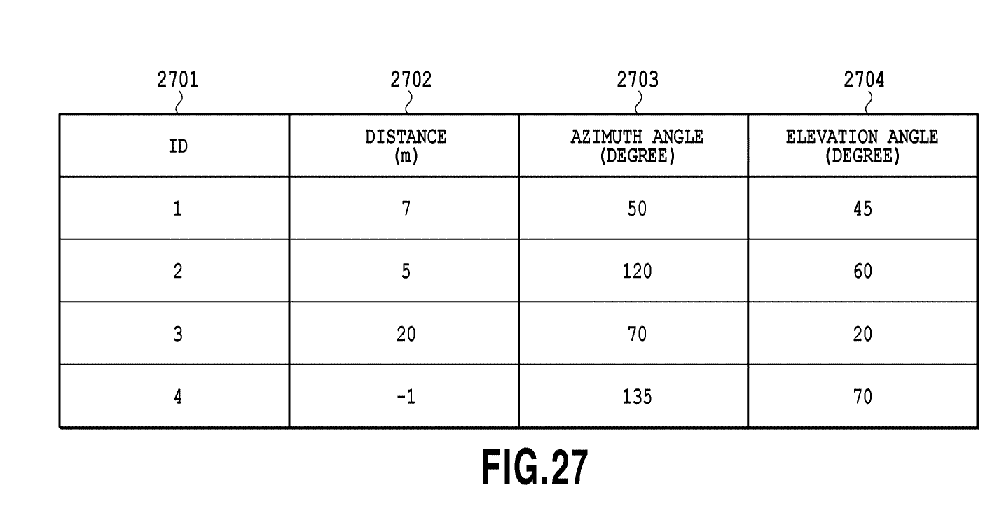

FIG. 27 shows an example of light source parameter tables. Reference numeral 2701 indicates ID for discriminating each light source. Regions each having a brightness value higher than a certain level in an all surrounding image are assumed as the light source and a weighted center thereof is assumed as the position of the light source. Reference numeral 2702 indicates distance information from a background image capturing position to the light source. The distance unit is a meter. When the distance information cannot be obtained, the light source is assumed to exist at an infinite distance and a value of “−1” is retained. Reference numerals 2703 and 2704 indicate light source directions when the light source is viewed from the background image capturing position and indicates an azimuth angle and an elevation angle, respectively. The angle unit is a degree. Note that, while the region having a brightness value higher than a certain level in the all surrounding image is assumed as the light source region here, this is an example and the present invention is not limited to this case. For example, each of the individual pixels may be treated as a light source. Furthermore, while the light source position is retained by the use of a polar coordinate system here, this is an example and the present embodiment is not limited to this case. For example, the light source position may be retained also by the use of an orthogonal coordinate system.

To return to explanation of FIG. 26, reference numeral 2605 in the drawing indicates a light propagation preliminary calculation result which is a preliminarily calculated result of light propagation. The calculation is performed by the use of a technique in “Peter-Pike Sloan and Ben Luna and John Snyder” Local, Deformable Precomputed Radiance Transfer “SIGGRAPH ACM ACM SIGGRAPH 2005 Papers” and “Zhong Ren and Rui Wang and John Snyder and Kun Zhou and Xinguo Liu and Bo Sun and Peter-Pike Sloan and Hujun Bao and Qunsheng Peng and Baining Guo” Real-time Soft Shades in Dynamic Scenes using Spherical Harmonic Exponentiation”, SIGGRAPH ACM SIGGRAPH 2006 Papers”, or the like. Reference numeral 2606 indicates a combined image which is an editing result of the video editing apparatus in the present embodiment. The foreground image 2601, background image 2602, background image depth information 2603, light source parameter 2604, light propagation preliminary calculation result 2605, and combined image 2606 are recorded in the storage medium 2304. Reference numeral 2610 indicates the video editing apparatus in the present embodiment. Reference numeral 2611 indicates a combining position obtaining unit configured to obtain coordinates on the background image as a combining position. The combining position obtaining unit 2611 obtains coordinates on the background image which the user has designated using the input device 2305, as the combining position. Furthermore, the combining position obtaining unit 2611 obtains coordinates on the background image for a pixel on the foreground image which is designated in advance by the user and becomes a reference point for the combining. Note that, while the reference point for the combining is designated by the user here, this is an example and the present embodiment is not limited to this case. For example, face detection is performed and the position of a face may be used as the reference for the combining position. Furthermore, the bottom part of an opaque part in the foreground image may be used as the reference for the combining position.

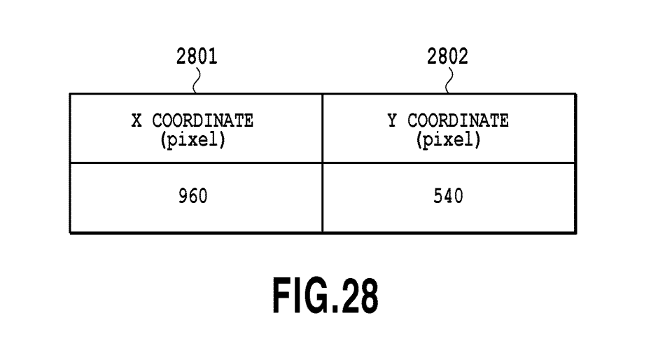

FIG. 28 shows an example of combining position information. Reference numeral 2801 indicates an X coordinate of the combining position on the background image and reference numeral 2802 indicates a Y coordinate thereof.

Successively, according to FIG. 26, the present embodiment will be explained. Reference numeral 2612 indicates a projection unit configured to generate projection information in which coordinates in a space generated from the background image depth information is projected to two-dimensional coordinates on the background image. The projection is performed by the use of a perspective projection method.

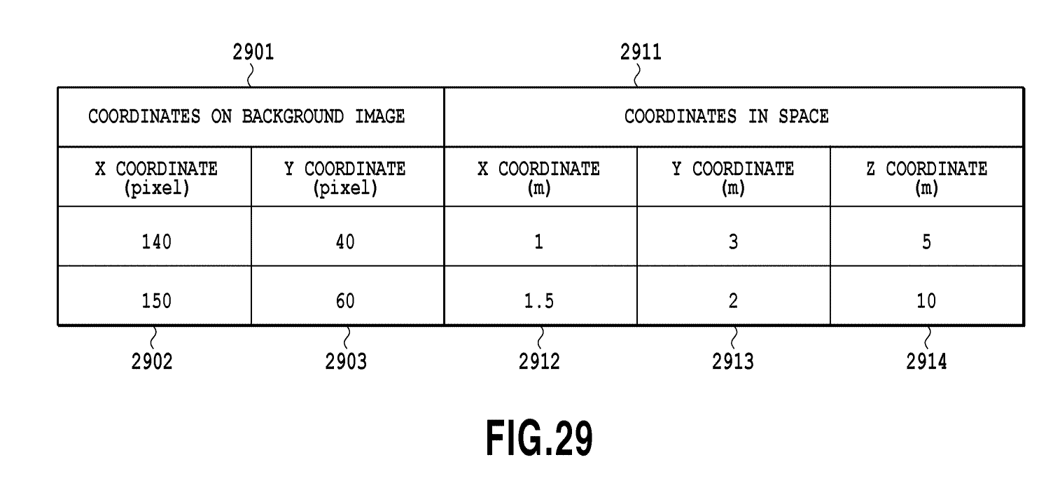

FIG. 29 shows an example of the projection information. Reference numeral 2901 indicates two-dimensional coordinates on the background image. Reference numeral 2902 indicates an X coordinate and reference numeral 2903 indicates a Y coordinate. Reference numeral 2911 indicates coordinates in the space generated from the background image depth information. Reference numeral 2912 indicates an X coordinate, reference numeral 2913 indicates a Y coordinate, and reference numeral 2914 indicates a Z coordinate. Note that this is an example and the present embodiment is not limited to this case. For example, an X coordinate, Y coordinate, and Z coordinate corresponding to each pixel on the background image may be retained in the RGB information as image information.

Successively, on the basis of FIG. 26, the present embodiment will be explained. Reference numeral 2613 indicates a space coordinate obtaining unit configured to obtain space coordinates corresponding to the coordinates on the background image obtained in the combining position obtaining unit 2611 on the basis of the projection information generated by the projection unit 2612.

Reference numeral 2614 indicates a light source distance or illuminance calculation unit configured to calculate a distance between the space coordinates of the combining position and the light source or calculate a light source illuminance when the light source is viewed from the space coordinates of the combining position. Details will be described below. Reference numeral 2615 indicates a light source parameter change unit configured to change the light source parameter. Details will be described below. Reference numeral 2616 indicates a lighting unit configured to provide a lighting effect for the foreground image according to the light source parameter changed by the light source parameter change unit 2615. Details will be described below. Note that, here, the lighting effect may be provided for the foreground image after processing of removing a shade part has been performed. The shade part removal is performed by the use of a technique disclosed in Japanese Patent Laid-Open No. 2010-135996 or the like. Reference numeral 2617 indicates a combining unit configured to combine the foreground image, which has been provided with the lighting effect by the lighting unit 2616, with the background image at the combining position obtained by the combining position obtaining unit 2611. The combining result of the combining unit 2617 is output to the recording medium 2304 and the output device 2306.

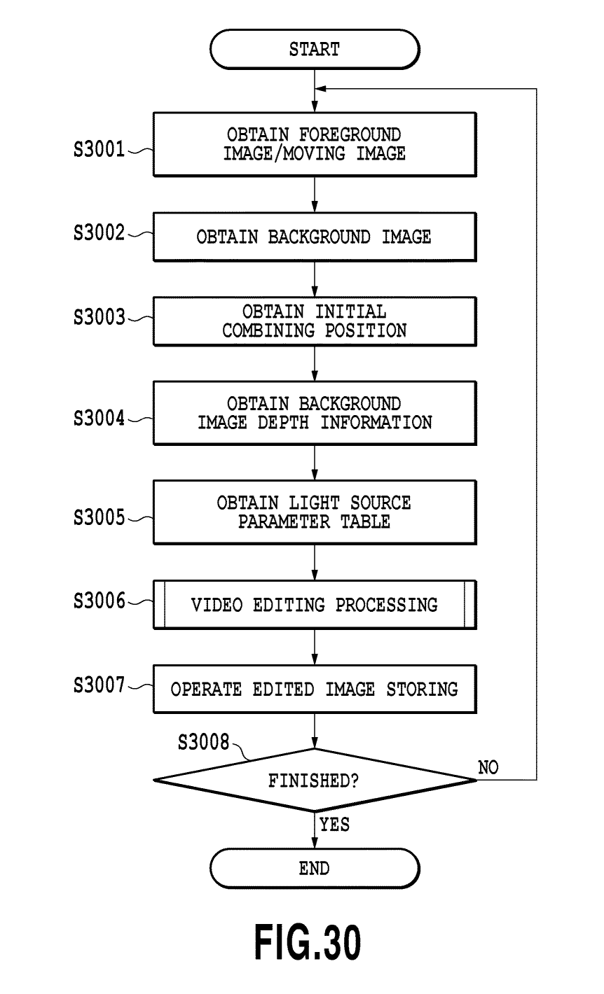

FIG. 30 shows a flowchart of a control processing sequence executed by the CPU 101 of the video editing apparatus in the present embodiment. When the video editing apparatus is activated, a foreground image selected by a user is obtained from the storage medium 2304 (S3001). In the present embodiment, a moving image is obtained. Next, a background image selected by the user from the storage medium 2304 is obtained (S3002).

An initial combining position is obtained from a user's input to the input device 2305 (S3003). From the storage medium 2304, depth information is obtained corresponding to the foreground a light source parameter is obtained corresponding to the background image obtained in S3002 (S3005). The video editing processing is started (S3006). Details of this video editing processing will be described below. An image after the editing has been completed is recorded in the storage medium 2304 (S3007). It is determined whether finishing operation has been performed or not (S3008). In the case where it is determined that the finishing operation has not been performed (S3008), a foreground image is obtained (S3001). In the case where it is determined that the finishing operation has been performed (S3008), the video editing apparatus is finished.

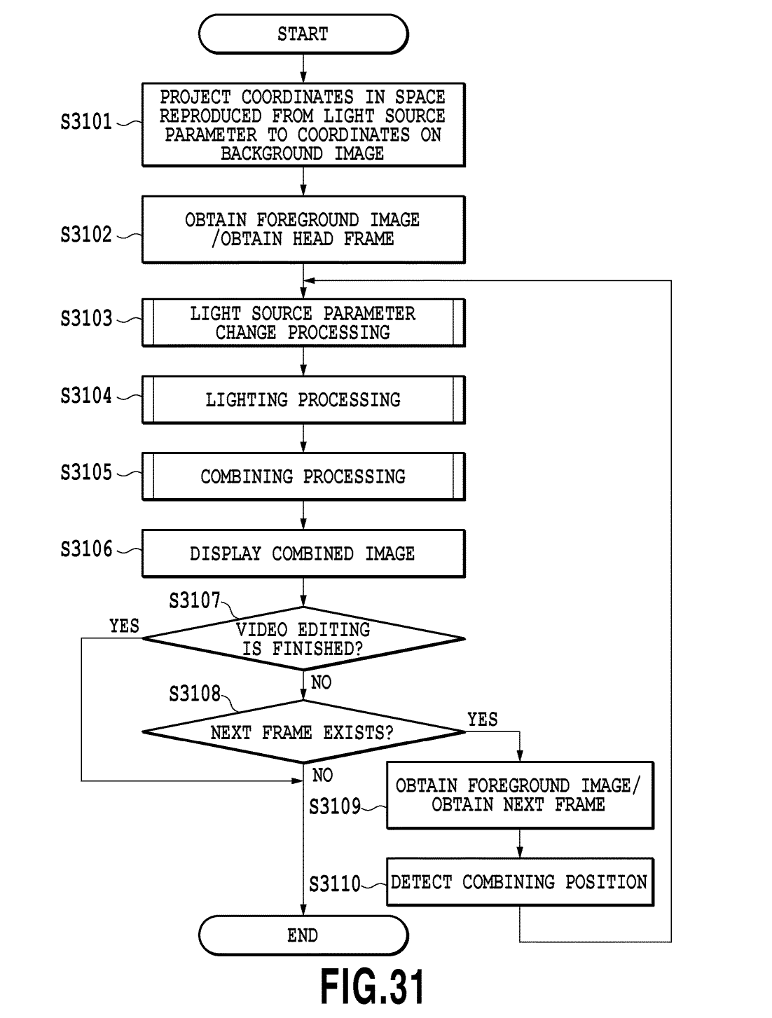

FIG. 31 shows a flowchart of the video editing processing in above S3006 in the present embodiment. When the video editing processing is started, coordinates of a space generated from the background image depth information obtained in S3004 are projected to the two-dimensional coordinates on the background image, and projection information is generated (S3101). Ahead frame is obtained from the foreground image obtained in S3001 (S3102). The light source parameter change processing is performed (S3103). Details of the light source parameter change processing will be described below. The lighting processing is performed (S3104). Details of the lighting processing will be described below. The combining processing is performed (S3105). Details of the combining processing will be described below. A combined image is displayed on the display device 106 (S3106). It is determined whether video editing finishing operation has been performed or not (S3107). In the case where it is determined that the finishing operation has been performed (S3107), the video editing processing is finished. In the case where it is determined that the finishing operation has not been performed (S3107), it is determined whether the next frame exists or not in the moving image used as the foreground image (S3108). In the case where it is determined that the next frame exists (S3108), the next frame of the moving image is obtained as a foreground image (S3109). A predetermined pixel in the foreground image is detected and the combining position is changed by a position change amount from the previous frame (S3110). In the case where it is determined that the next frame does not exists (S3108), the video editing processing is finished.

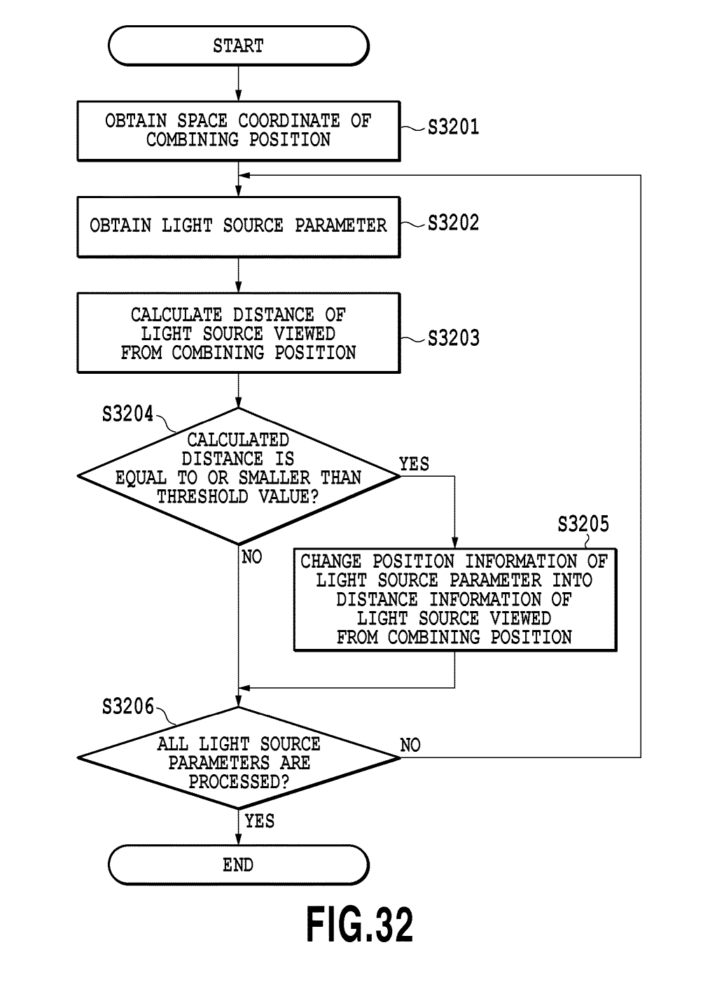

FIG. 32 shows a flowchart of the light source parameter change processing S3103 in the present embodiment. When the light source parameter change processing is started, space coordinates of the combining position is obtained from the projection information generated in S3101 (S3201). Alight source parameter is obtained from the light source parameter table obtained in S3005 (S3202). A light source distance is calculated from the space coordinates of the combining position obtained in S3201 and the light source parameter obtained in S3202, by the use of formula (5) and formula (6) (S3203).

Distance information 2702 in the light source parameter is set to R, an azimuth angle 2703 is set to θ, and an elevation angle 2704 is set to φ. The X coordinate, Y coordinate, and Z coordinate of the space coordinates at the combining position are set to X_{C}, Y_{C}, and Z_{C}, respectively. A distance to be calculated is set to R₁.

X₁=R·cos(θ)cos(φ)−X_{C}

Y₁=R·sin(θ)cos(φ)−Y_{C}

Z₁=R·sin(θ)−Z_{C} (5)

R₁={X₁²+Y₁²+Z₁²}^{1/2} (6)

Then, in S3204, it is determined whether or not the value calculated in S3203 is equal to or smaller than a threshold value. Only in the case where the value is determined to be equal to or smaller than the threshold value, the light source parameter change processing is performed by the use of the space coordinates of the combining position obtained in S3201 and the light source parameter obtained in S3202 (S3205). The parameter change is performed by the use of formula (7) and formula (8).

Distance information 2702 of the light source parameter is set to R, an azimuth angle 2703 is set to θ, and an elevation angle 2704 is set to φ. An X coordinate, Y coordinate, and Z coordinate of the space coordinates at the combining position are set to X_{C}, Y_{C}, and Z_{C}, respectively. The X coordinate, Y coordinate, and Z coordinate of the light source after the light source parameter change are set to X₁, Y₁, and Z₁, respectively. Distance information 2702 after the light source parameter change is set to R₁, an azimuth angle 2703 is set to θ₁, and an elevation angle 2704 is set to φ₁.

X₁=R·cos(θ)cos(φ)−X_{C}

Y₁=R·sin(θ)cos(φ)−Y_{C}

Z₁=R·sin(θ)−Z_{C} (7)

R₁={X₁²+Y₁²+Z₁²}^{1/2}

θ₁=arccos {X₁/{X₁²+Y₁²}^{1/2}}}

φ₁=arcsin {Z₁/{X₁²+Y₁²}^{1/2}}} (8)

It is determined whether all the light source parameters have been processed or not (S3206). In the case where it is determined that all the light source parameters have not been processed (S3206), the next light source parameter is obtained (S3201). In the case where all the light source parameters have been processed (S3206), the light source parameter change processing is finished. Note that this light source parameter change processing is an example and the present embodiment is not limited to this case. For example, for the light source parameter, the all surrounding image and the depth information thereof are retained as image information. The image is divided for each light source. Rotation, parallel translation, enlargement, and shrink processing is provided for the divided image of each light source so as to cause the direction of the light source viewed from the combining position to be the same. The light source parameter change processing may be performed in this manner.

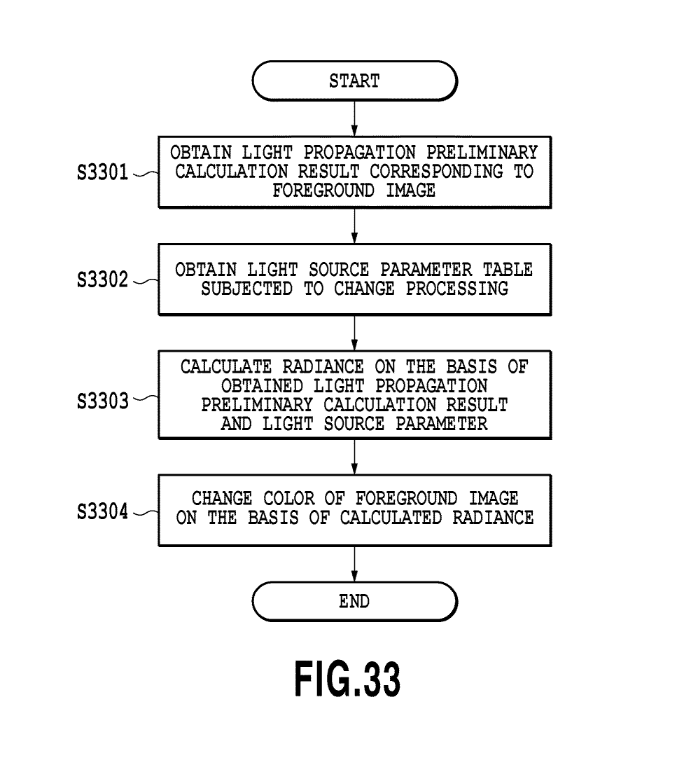

FIG. 33 shows a flowchart of the lighting processing S3104 in the present embodiment. Preliminarily calculated light propagation information such as self screening information and screening information is obtained by the use of a shape of the foreground image (S3301). The foreground image is obtained by stereo image capturing and the shape of the foreground image is estimated by the use of the depth information obtained by stereo matching. The light source parameter table provided with the change processing in S3103 is obtained (S3302). Radiance of each pixel is calculated by the use of the obtained light source parameter and the light propagation information (S3303). The color of each pixel in the foreground image is changed by the use of the calculated radiance (S3304). Note that the light propagation calculation and the radiance calculation are performed by the use of a technique described in a document such as Peter-Pike Sloan and Ben Luna and John Snyder “Local, Deformable Precomputed Radiance Transfer” SIGGRAPH ACM ACM SIGGRAPH 2005 Papers and Zhong Ren and Rui Wang and John Snyder and Kun Zhou and Xinguo Liu and Bo Sun and Peter-Pike Sloan and Hujun Bao and Qunsheng Peng and Baining Guo “Real-time Soft Shades in Dynamic Scenes using Spherical Harmonic Exponentiation”, SIGGRAPH ACM SIGGRAPH 2006 Papers.

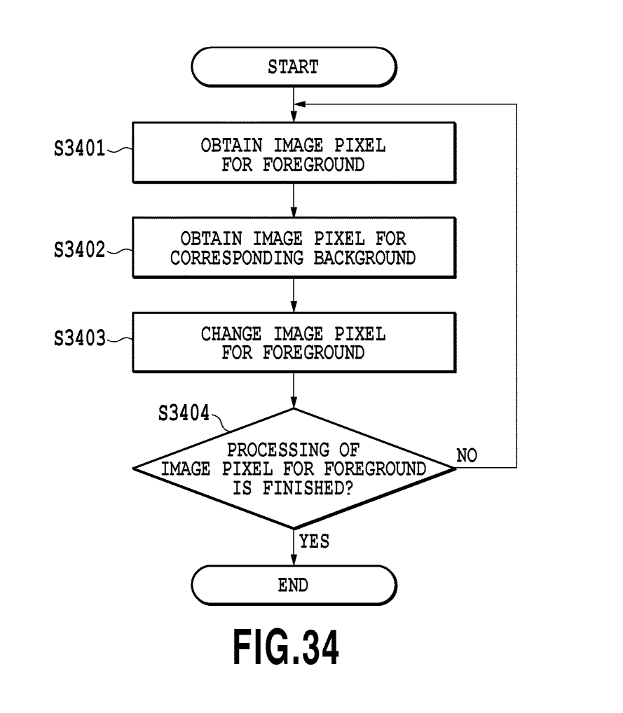

FIG. 34 shows a flowchart of the combining processing S3105 in the present embodiment. A pixel of the foreground image is obtained (S3401). A background pixel is obtained at a position where the above obtained pixel is to be combined (S3402). When a pixel value of the foreground image is set to F, an α value of the foreground image is set to α, a pixel value of the background image is set to B, and a pixel value after combining is set to C, the combining processing is performed by the use of formula (9) (S3403).

C=Fα+B(1−α) (9)

By carrying out such configuration and processing, it is possible to easily provide the foreground image with the lighting effect corresponding

to the combining position, and a natural image is generated as the combined image 2606 even for the combined video image. After that, reproduction processing of this combined image 2606 is performed by user's designation.

### Example 4

Next a fourth embodiment will be explained. Note that explanation will be omitted for a portion according to example 3. In the present embodiment, a still image is used for the foreground image, and a user designates a desired combining position by drag operation. In this case, the lighting effect is provided for the foreground image according to the change of the combining position. Furthermore, according to the intensity of the light source, it is determined whether the light source parameter is changed or not.

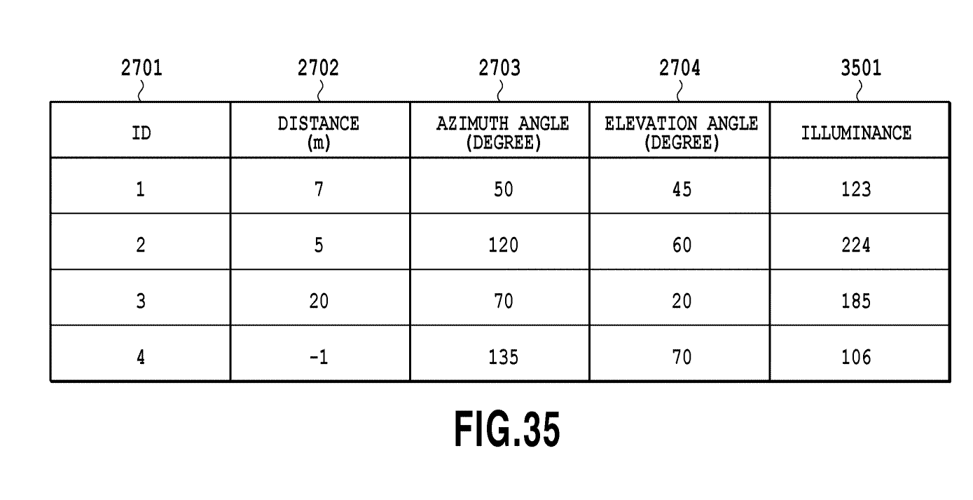

FIG. 35 shows an example of the light source parameter in the present embodiment. Explanation will be omitted for a portion according to example 3. Reference numeral 3501 indicates ililluminance information of the light source. In the present embodiment, the RGB values of each pixel of the all surrounding image are converted into XYZ values by the use of formula (10), and the Y value is obtained as the ililluminance.

X=0.412453R+0.35758G+0.180423B

Y=0.212671R+0.71516G+0.072169B

Z=0.019334R+0.119193G+0.950227B (10)

Note that this is an example and the present embodiment is not limited to this case. For example, the RGB values may be converted into HSV values and the V value may be used as the ililluminance.

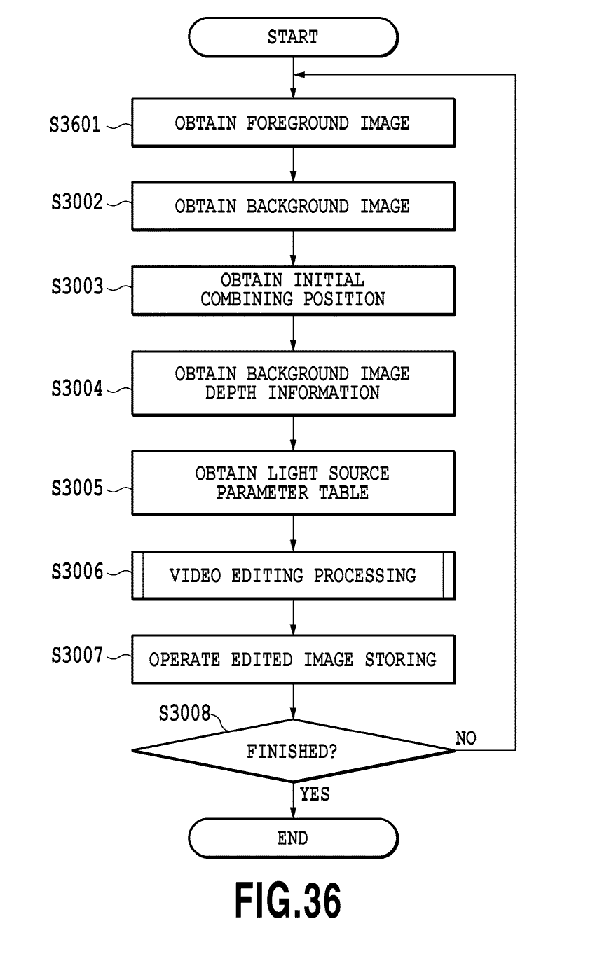

FIG. 36 shows a flowchart of the video editing apparatus in the present embodiment. Explanation will be omitted for a portion according to example 3. A still image selected by a user as a foreground image is obtained from the storage medium 2304 (S3601).

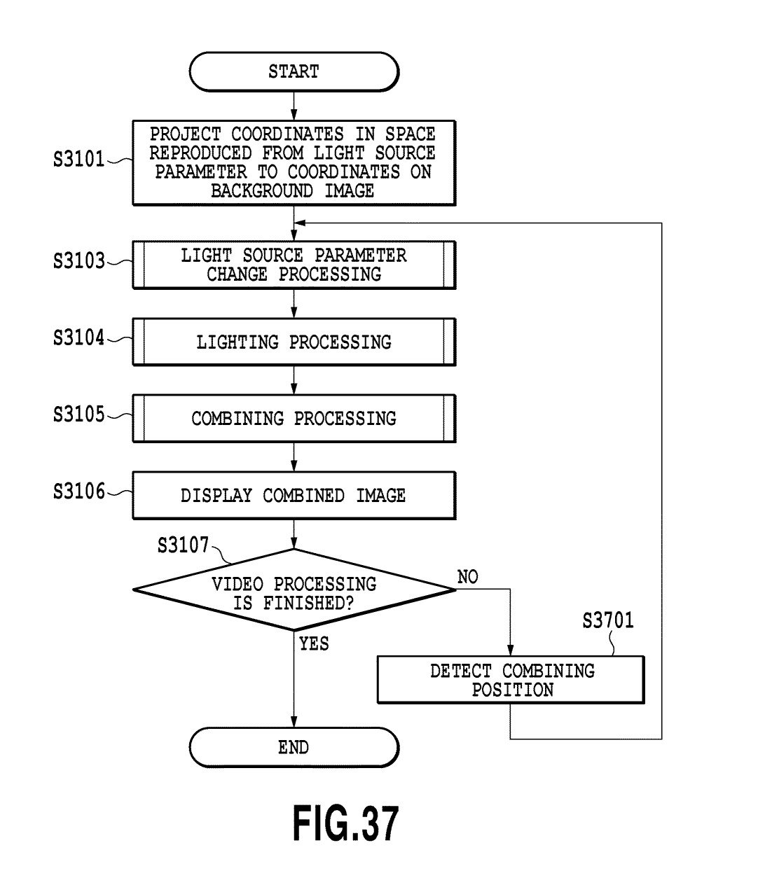

FIG. 37 shows a flowchart of the video editing processing S3006 in the present embodiment. Explanation will be omitted for a portion according to example 3. A combining position is obtained from a user's input in the input device 2305 (S3701).

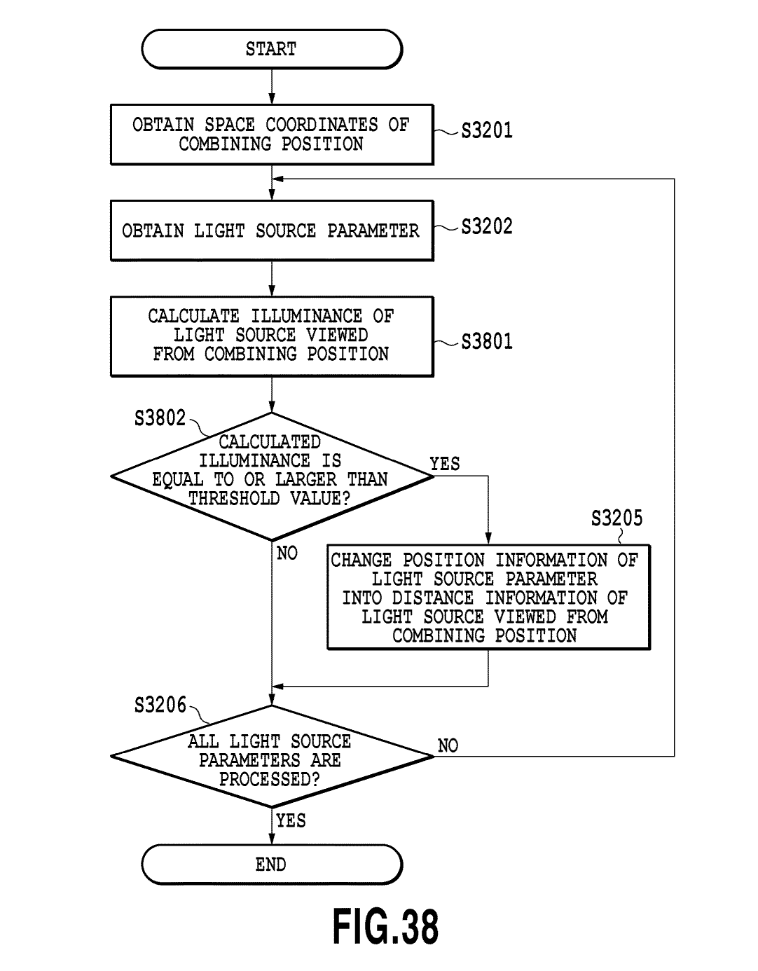

FIG. 38 shows a flowchart of the light source parameter change processing S3103 in the present embodiment. Explanation will be omitted for a portion according to example 3. A distance of the light source from the space coordinates of the combining position obtained in S3106 is calculated by the use of formula (5) and formula (6). Illuminance viewed from the space coordinates of the combining position is calculated from the calculated distance and the light source parameter by the use of formula (11) (S3801). A illuminance of the light source parameter is set to E and an illuminance to be calculated is set to E₁.

E₁=E(R·R)/(R₁·R₁) (11)

Note that this is an example and the present embodiment is not limited to this case. Illuminance E of the light source parameter may be used as a determination reference. It is determined whether or not the calculated illuminance is equal to or higher than a predetermined threshold value (S3802). In the case where the calculated illuminance is higher than the threshold value (S3802), the light source parameter is changed (S3205). Note that, while the position information of the light source parameter is changed in S3205, this is an example and the present embodiment is not limited to this case. The illuminance information of the light source parameter may be changed by the use of formula (5). In the case where the calculated illuminance is less than a threshold value (S3802), it is determined whether all the light source parameters have been processed or not (S3206).

By carrying out such configuration and processing, it is possible to easily provide the foreground image with the lighting effect corresponding to the combining position, and a natural image can be obtained even for the combined video image.

### Example 5

Next, a fifth embodiment will be explained. Note that explanation will be omitted for a portion according to example 3 or example 4. In the present embodiment, it is determined depending on a change amount of the combining position whether the calculation processing of S3107, the determination processing of S3108, and the light source parameter change processing of S3109 are performed or not.

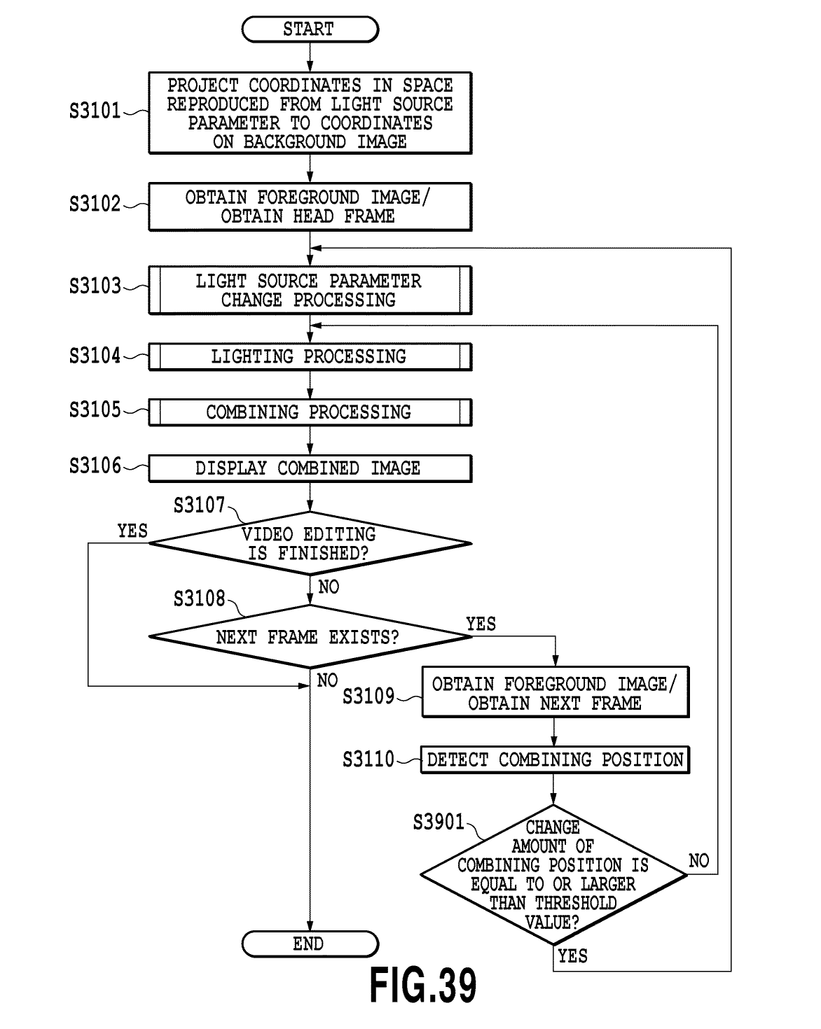

FIG. 39 shows a flowchart of the video editing processing in the present embodiment. Note that explanation will be omitted for a portion according to example 3 or example 4. As shown in the drawing, the present embodiment has a step (S3901) of determining whether or not the change amount of the combining position is equal to or larger than a threshold value (whether or not the change amount of the combining position exceeds a predetermined range). Then, in the case where it is determined that the combining position change amount is less than the threshold value, that is, within the predetermined range (No in S3901), the lighting processing is performed (S3104). Then, in the case where it is determined that the combining position change amount is equal to or larger than the threshold value (Yes in S3901), the light source parameter change processing is performed (S3103).

By carrying out such configuration and the processing, it is possible to easily provide the foreground image with the lighting effect corresponding to the combining position and a natural image can be obtained even for the combined video image.

### Example 6

Next, a sixth embodiment will be explained. Note that explanation will be omitted for a portion according to any of examples 3 to 5. In the present embodiment, many light source parameters are generated in advance corresponding to the combining positions as preparatory processing before the video editing. In the video editing processing, a light source parameter corresponding to the combining position is obtained and the lighting effect is provided.

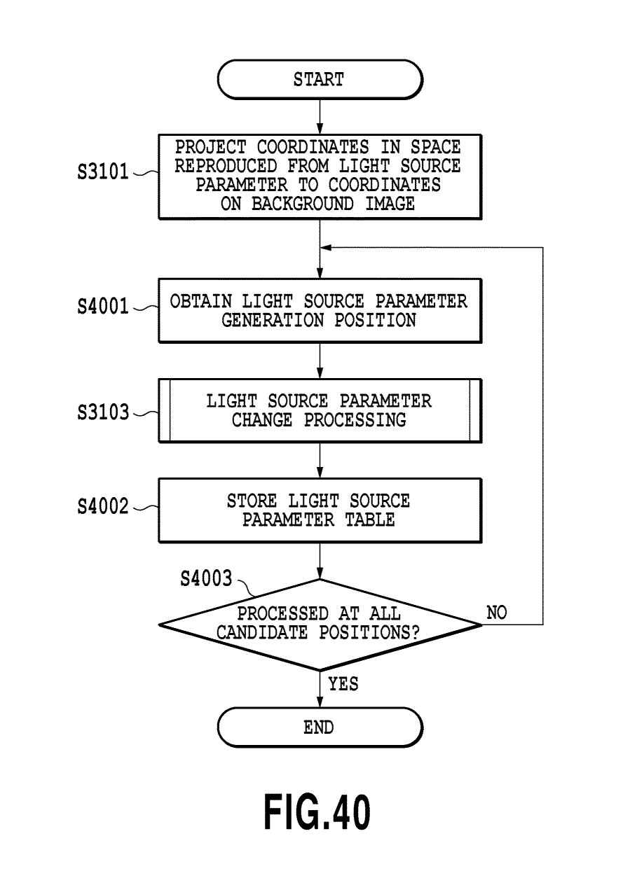

FIG. 40 shows a flowchart of the preparatory processing in the present embodiment. Note that explanation will be omitted for a portion according to any of examples 3 to 5. Positions sampled on the background image at regular intervals are obtained as candidate positions for which the light source parameters are in advance generated (S4001). Note that this is an example and the present embodiment is not limited to this case. For example, a position preliminarily designated by a user may be a generation candidate position. Furthermore, the light source parameter may be generated only at a position having a distance of a certain value or smaller. The changed light source parameter is recorded in the storage medium (S4002).

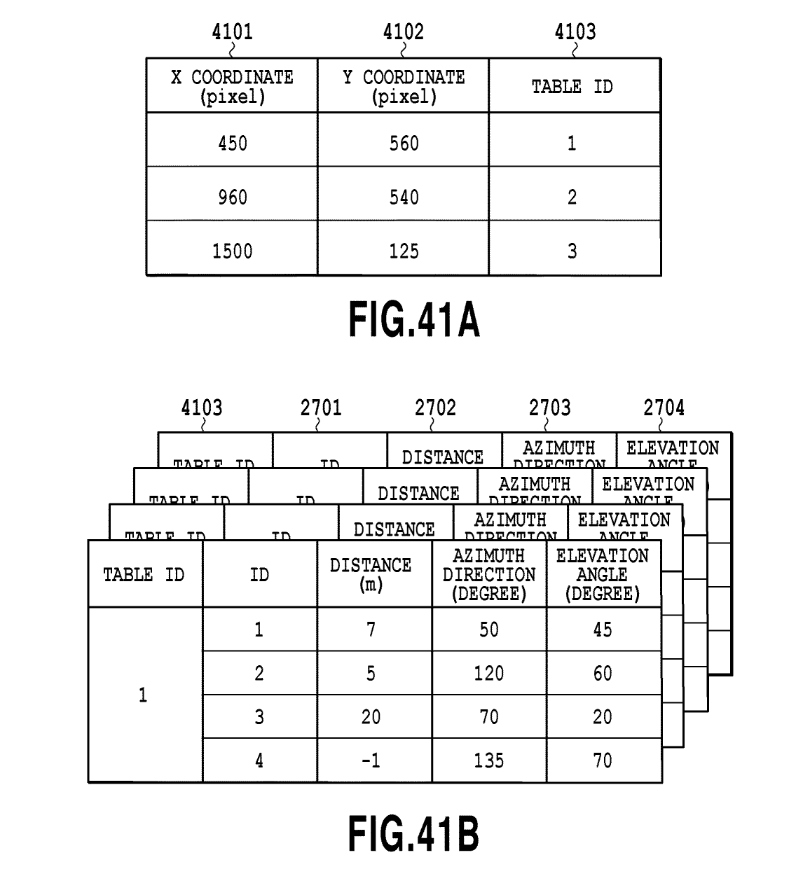

FIGS. 41A and 41B show examples of the light source parameter recorded in the storage medium in the present embodiment. FIG. 41A is a table associating light source parameter tables corresponding to the combining positions with one another. Reference numeral 4101 indicates an X coordinate of the combining position on the background image and the unit is a pixel. Reference numeral 4102 indicates a Y coordinate of the combining position on the background image and the unit is a pixel. Reference numeral 4103 indicates an table ID for discriminating a light source parameter table uniquely. FIG. 41B shows light source parameter tables.

Successively, the preparatory processing of the present embodiment will be explained by the use of FIG. 40. It is determined whether the light source parameter has been generated for all the candidate positions (S4003). In the case where it is determined that the light source parameter has not been generated for all the candidate positions (No in S4003), the next candidate position is obtained (S4001). In the case where it is determined that the light source parameter has been generated for all the candidate positions (Yes in S4003), the preparatory processing is finished.

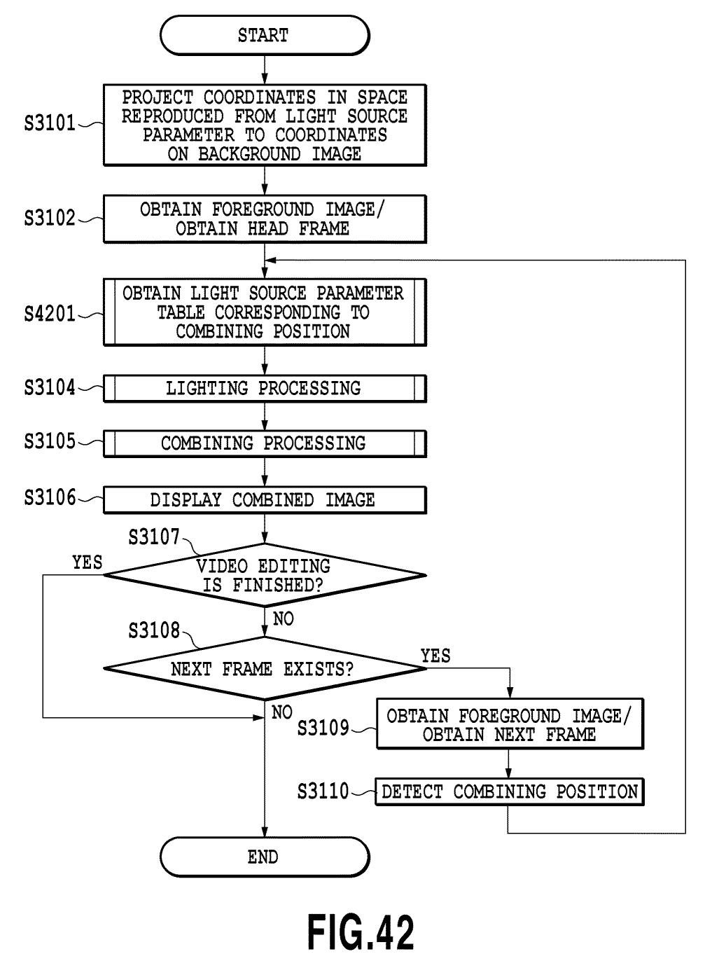

FIG. 42 shows a flowchart of the video editing processing in the present embodiment. Note that explanation will be omitted for a portion according to any of examples 3 to 5. Among the light source parameters generated in the preparatory processing, the light source parameter generated at a position nearest to the combining position is obtained from the storage medium (S4201). Note that, while the light source parameter at the position nearest to the combining position is obtained here, this is an example and the present embodiment is not limited to this case. For example, plural light source parameters generated at positions adjacent to the combining position are obtained and a light source parameter may be generated by linear interpolation by the use of respective distances in the light source parameters.

By carrying out such configuration and processing, it is possible to easily provide the foreground image with the lighting effect corresponding to the combining position, and a natural image can be obtained even for the combined video image.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2012-011506, filed Jan. 23, 2012, and 2012-014200, filed Jan. 26, 2012, which are hereby incorporated by reference herein in their entirety.

What is claimed is:

1. An image processing apparatus, comprising:
a surrounding environment three-dimensional shape data generation unit configured to generate surrounding environment three-dimensional shape data from environment map data, wherein the environment map data consists of a plurality of environment maps captured from two or more viewpoints; and
an image generation unit configured to generate an image of a virtual subject by using the surrounding environment three-dimensional shape data as a light source.

2. The image processing apparatus according to claim 1, wherein
the image generation unit generates an image which combines the virtual subject with a background image by using the surrounding environment three-dimensional shape data as a light source.

3. The image processing apparatus according to claim 1, wherein
the surrounding environment three-dimensional shape data generation unit generates the surrounding environment three-dimensional shape data by generating a distance map from the environment map data.

4. The image processing apparatus according to claim 1, wherein
the surrounding environment three-dimensional shape data is data which expresses three-dimensional space coordinates of a subject corresponding to each pixel in the environment map.

5. The image processing apparatus according to claim 3, wherein
the distance map expresses, as a pixel value, a distance of a subject corresponding to each pixel in the environment map, from an image capturing position.

6. The image processing apparatus according to claim 1, further comprising
an unnecessary subject removal unit configured to remove an unnecessary subject from the environment map.

7. The image processing apparatus according to claim 6, wherein,
as a result of the unnecessary subject removal from the environment map, a pixel value in a removed region is replaced by a pixel value in an adjacent region thereof on the environment map.

8. The image processing apparatus according to claim 6, wherein
the unnecessary subject is a subject existing at a distance smaller than a predetermined distance.

9. The image processing apparatus according to claim 6, wherein
the unnecessary subject removal unit determines the unnecessary subject by comparing a pixel value in the distance map with a predetermined distance value.

10. The image processing apparatus according to claim 6, wherein
the unnecessary subject is a person.

11. The image processing apparatus according to claim 10, wherein
the unnecessary subject of a person is specified by determining a region for the person in the environment map by face recognition.

12. The image processing apparatus according to claim 10, wherein
the unnecessary subject of a person is specified by determining a region for the person by extraction of flesh color in the environment map.

13. An image processing method, comprising the steps of:
generating surrounding environment three-dimensional shape data from environment map data, wherein the environment map data consists of a plurality of environment maps captured from two or more viewpoints; and
generating an image of a virtual subject by using the surrounding environment three-dimensional shape data as a light source.

14. A program stored in a non-transitory computer readable storage medium for causing a computer to perform the image processing method according to claim 13.
